(19) United States
(12) Patent Application Publication
(10) Pub. No.: US 2021/0045397 A1
(43) Pub. Date: Feb. 18, 2021

(54) LACTOSE FREE MILK PRODUCTS

(71) Applicants: Agritechnology Pty Ltd, Borenore via Orange (AU); Ingredients Advisory Services Pty Ltd, kiama (AU)

(72) Inventors: Graham Dean HOBBA, Millthorpe (AU); Robert John PEARCE, Kiama (AU)

(21) Appl. No.: 16/977,634

(22) PCT Filed: Mar. 5, 2018
(86) PCT No.: PCT/AU2018/050201

§ 371 Date: Sep. 2, 2020

(51) Int. Cl. A23C 9/13; A23C 9/142; A23C 9/156; A23L 29/30; A23L 33/125

(52) U.S. Cl. CPC A23C 9/1307; A23C 9/1422; A23L 33/125; A23L 29/30; A23C 9/156

(57) ABSTRACT

Described herein are liquid, concentrated or dried lactose-free skim milk products or lactose-free, fat containing milk products that exhibit stability during thermal processing and storage as a result of the reductive carbohydrate to milk protein ratio of the milk products. The osmolality of the lactose-free milk products described herein also enable improved nutritional availability when compared to commercially available lactose hydrolysed milk products.

### TECHNICAL FIELD

Lactose-free skim milk products or lactose free fat containing milk products with nutritional, organoleptic and functional properties similar to dairy milk and additional benefits of reduced osmolality and improved stability during thermal processing and method for preparation.

### BACKGROUND

Milk is the lacteal secretion of all mammalian species produced for the nutrition of neonates. The milk of a number of species of mammals including cow, goat, sheep, buffalo, camel, llama, yak, horse, reindeer and others is utilised to manufacture dairy products for human consumption. Mammalian milk contains protein, fat, minerals and lactose but differs in relative proportions of components and species-specific compositional variation. On a dry solids weight % basis, cow milk contains about 38% lactose and 25% protein with a consequent sugar to protein ratio of about 1.5 for both milk with natural fat content, and commercial skim milk.

Neonates of all mammalian species depend on maternal milk for their nutrition until grown sufficiently such that their digestive system allows other food materials to be consumed and nutrients utilised. Humans have learned to domesticate animals for the purpose of producing milk for their own nutrition especially for the growth and development of their children. Dairy milk is an important source of minerals; typical content per 100 mL whole milk being: calcium (110-130 mg); potassium (110-170 mg); phosphorus (90-100 mg); magnesium (9-14 mg) together with trace minerals including zinc, manganese and fluoride plus vitamins: thiamine, riboflavin and B12.

Milk is a highly desirable component of human diets not only due to its recognised beneficial balanced nutritional attributes, but also its organoleptic characteristics and functionality as an ingredient in a wide range of applications. It can also be dried with care without major loss of nutritional or other properties either as dried skim milk (low-fat) or whole milk (fat containing) products with compositions as shown in Table 1.

TABLE 1
Typical nutritional specification for cow milk powder products.

% dry solids basis

| | Skim Milk | Whole Milk |
|---|---|---|
| | Powder | Powder |
| Principal components | (SMP) | (WMP) |
| Protein | 34-37 | 24-27 |
| Carbohydrate (lactose) | 49-52 | 36-39 |
| Ash | 8.0-8.8 | 5.5-6.5 |
| Fat | 0.6-1.3 | 26-29 |
| Energy KJ/kg | 14.6 | 20.6 |

Desirability factors for consumers of liquid milk include nutritional characteristics, ready digestibility, flavour (including sweetness), colour, texture, aroma and functionality in applications such as custards, soups, cakes, yoghurt, milk chocolate and ice-cream. Functionalities of milk products in food applications include water binding, emulsification, whipping, foaming and gelling or thickening. Attractiveness to food processors includes dryability for storage and transport, minimal hygroscopicity of dried product and ease of reconstitution.

Lactose, the major constituent of cow milk primarily provides energy to the consumer but it also contributes other aspects of desirability to milk as food that can be processed and preserved and used in a wide range of food types including beverages, cheeses, yoghurts, desserts, baked goods and milk chocolate. In such food, the lactose may provide sweetness and flavour, fermentability, viscosity, a major contribution to the osmolality and may affect the colloidal behaviour of other milk constituents such as micellar casein. (Walstra, P., Jenness, R. & Badings, H. T. (1984) Dairy Chemistry and Physics publ Wiley; Fox, P. F. & McSweeney, P. L. H. (1998) Dairy Chemistry and Biochemistry, publ Springer Science & Business Media.). Therefore, the substitution of lactose with alternative digestible carbohydrates has the potential to affect a broad range of physical, organoleptic and functional properties of a milk composition. For example, the presence of glucose oligosaccharides may markedly change the emulsification and thickening properties if used as a lactose substitute in a lactose-free milk product.

In certain geographical regions and among certain anthropological types, many people have either lost or not acquired the ability to completely digest the lactose of milk beyond weaning whereupon incomplete digestion may result in adverse symptoms including intestinal fermentation, distention, discomfort and diarrhoea. The occurrence of lactose intolerance has been estimated as being between 5% in Europe to more than 90% in Asia and Africa.

Additionally, the osmotic impact of a food composition can adversely affect the efficiency of utilisation of the available nutrition. More rapid gastric emptying may result from intake of hypo-osmotic food compositions delivering improved nutritional availability. See for example, Vist, G. E. and Maughan, R. J (1995) Journal of Physiology 486(2), 523-531 which describes the effect of osmolality and carbohydrate content on the rate of gastric emptying of liquids in man.

The inability of certain individuals to comfortably digest dairy milk is now known to be due to a rapid decline after weaning in the production of the intestinal digestive enzyme lactase (beta-D-galactosidase), the enzyme that converts the disaccharide lactose into its component monosaccharides, glucose and galactose. (see Yang Yuexin, Mei He Hongmei Cui and Zhu Wang (2001) The Prevalence of Lactase Deficiency and Lactose Intolerance in Chinese Children of Different Ages. Chinese Medical Journal 113(12):1129-1132). Lactose is not absorbed by the small intestines but both glucose and galactose are absorbed. Thus, certain individuals are disadvantaged in their food and nutrition options through this condition referred to as lactose intolerance. This has led to the development of carbohydrate-modified milk products that are reduced in lactose content. A carbohydrate-modified milk product is characterised as lactose free if it contains 0.2% by weight or less lactose in the product on a dry solids basis.

Several methods have been described for the production of reduced-lactose milk products with similar characteristics when compared to natural milk. Lactose-reduced milk products typically contain 2-20% by weight of the natural content of lactose after lactose removal by filtration (which results in a change in nutritional balance) or by the enzymatic or chemical hydrolysis of lactose to a combined equal weight of glucose and galactose. The glucose and galactose generated by lactose hydrolysis results in an approximately four-fold increase in product sweetness and a doubling in reducing power of the sugar fraction. The reducing power of the sugar fraction in the milk product refers to the ability of a sugar to react with protein in Maillard reactions which can cause browning of the milk product. The reaction of reducing sugars such as glucose and galactose with milk proteins by way of Maillard reactions especially at elevated temperature and the resulting loss of nutritional value as well as the development of negative organoleptic features such as moisture uptake, caking and loss of nutritional value due to greater hygroscopicity, is generally understood, as summarised by van Boekel (1998) “Effect of heating on Maillard reactions in milk”, Food Chemistry, Vol. 62, No. 4, 403-414. As lactose, glucose and galactose are all reducing sugars, lactose hydrolysis can have a dramatic impact on the susceptibility of the lactose-reduced milk to Maillard reactions both during thermal processing and storage as discussed by Jansson, T., Clausen, M. R., Sundekilde, U. K., Eggers, N., Nyegaard, S., Larsen, L. B., Ray, C., Sundgren, A., Andersen, H. J. and Bertram H. C. (2014) Lactose-hydrolysed milk is more prone to chemical changes during storage than conventional ultra-high-temperature (UHT) milk”, J. Agricultural and Food Chemistry, Vol. 62, 7886-7896.

Methods of addressing the issues of increased sweetness and increased browning of lactose hydrolysed milk products have been proposed including the removal of glucose and galactose by filtration. The preparation of a lactose-hydrolysed milk with low sweetness using nanofiltration to remove the glucose and galactose without significant loss of calcium followed by reconstitution with water has been described in Choi, S. H., Lee, S-B, and Won, H-R (2007) Development of Lactose-Hydrolysed Milk with Low Sweetness Using Nanofiltration Asian-Aust. J. Anion. Sci 20:6, 989-993. Although the sweetness of this composition was reduced when compared to lactose hydrolysed milk, the carbohydrate content was not restored resulting in a loss of nutritional balance and greatly reduced efficiency of production.

There remains a need for lactose free milk products that have a similar nutritional balance and sweetness to dairy milk despite the lack of lactose. There also remains a need for lactose free milk products that have reduced osmolality to improve nutritional availability. There also remains a need for lactose free milk products that can be mechanically and/or thermally processed and stored without encountering the problems of browning, discolouration, milk protein degradation and hygroscopicity as exhibited by commercially available lactose hydrolysed milk products.

### SUMMARY OF THE INVENTION

According to a first aspect of the present invention there is provided a skim milk product or fat containing milk product comprising a concentrated milk protein component and a carbohydrate component wherein the carbohydrate component includes:
(i) an amount of a DP1 sugar selected from glucose, galactose, fructose or a combination thereof that is in total 3.0-18.0% w/w of the total carbohydrate component, and
(ii) an amount of a DP2 sugar selected from maltose, lactose, sucrose, di-fructose or a combination thereof that is in total 2.0-40.0% w/w of the total carbohydrate component, and
(iii) one or more digestible polysaccharide hydrolysates selected from dextrins, maltodextrins, malto-triose, glucose syrups, polyfructose, fructose syrups or a combination thereof wherein the one or more digestible polysaccharide hydrolysates provide in total an amount of a DP3 oligosaccharide that is 6.0-26.0% w/w of the total carbohydrate component, and
(iv) less than 0.2% w/w of lactose on a dry solids basis.

The milk protein component of the milk product according to the first aspect is between 23.0%-38.0% w/w of the product on a dry solids basis and the milk product has a reductive carbohydrate (DP 1+DP2+DP3) to milk protein mass ratio of 10.0-70.0.

According to a second aspect of the present invention, the milk product has a reductive carbohydrate (DP1+DP2) to milk protein mass ratio of 7.0-56.0.

According to a third aspect of the present invention, the milk product has a carbohydrate mass (DP1+DP2+DP3) to milk protein mass ratio of 0.20-1.15.

According to a fourth aspect of the present invention, the milk product has a sugar mass (DP1+DP2) to milk protein mass ratio of 0.08-0.80.

According to a fifth aspect of the present invention, the total mass of the DP1 sugar on a dry solids basis of the milk product is greater than the total mass of the DP2 sugar on a dry solids basis.

One or more of these aspects of the present invention can be combined in order to characterise the milk products described herein.

### DETAILED DESCRIPTION

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Documents referred to within this specification are included herein in their entirety by way of reference.

The reference to any prior art in this specification is not, and should not be taken as, an acknowledgment or any form of suggestion that that prior art forms part of the common general knowledge in Australia.

The present invention relates to lactose-free skim milk products or lactose-free fat containing milk products that include a concentrated milk protein component and a carbohydrate component. The term “skim milk product(s)” as used herein is to be understood as containing no added fat but may contain a low level of intrinsic fat containing material that is not collected with the cream in the standard dairy industry centrifugal process for separating cream from skim milk. The term “lactose-free” as used herein is to be understood to include milk products that comprise less than 0.20% w/w of lactose on a dry solids basis, more specifically, less than 0.15% w/w of lactose on a dry solids basis, even more specifically less than 0.10% w/w of lactose on a dry solids basis, and even more specifically between 0%-0.05% w/w of lactose on a dry solids basis.

The concentrated milk protein component of the skim milk products described herein is either a milk protein concentrate, a microfiltered milk protein concentrate or a milk protein isolate that is obtained, for example, from the milk of domesticated mammals such as cow, sheep, buffalo, camel, llama, reindeer, horse, yak or goat. The concentrated milk protein component is preferably between 23.0-38.0% w/w of the milk product on a dry solids basis.

The concentrated milk protein component can contain 50.%-95.0% of milk protein on a weight to weight (w/w) basis, more specifically 60.0%-92.0% milk protein on w/w basis and even more specifically 70.0-91.0% milk protein on w/w basis. The concentrated milk protein component can contain 0.005-20.0% carbohydrates such as lactose on w/w dry solids basis, more specifically 0.05%-16.0% carbohydrates on a w/w dry solids basis and even more specifically less than 10.0% carbohydrates on a w/w dry solids basis.

As aforesaid, milk protein can react with reducing sugars via Maillard reactions especially during heating. It has been discovered by the inventors that carbohydrate modified milk products that have a particular ratio of sugar reducing power to milk protein content will enable mechanical and/or thermal processing and storage stability of the milk products while avoiding or minimizing the occurrence of browning, discolouration, milk protein degradation and/or hygroscopicity when compared to a lactose hydrolysed commercially available milk product.

Lactose and its hydrolysed derivatives, glucose and galactose, are all reducing sugars. Other sources of reducing sugars in the lactose free milk products of the present invention are polysaccharide hydrolysates that are digestible by humans and animals. Examples of digestible polysaccharides that can be partially or completely hydrolysed include starch and inulin (polyfructose). Those resulting from the partial hydrolysis of starch can include dextrins, maltodextrins, malto-triose and glucose syrups.

As starch is a polymer of glucose its partial hydrolysis gives rise to maltodextrins having multiple components of different Degrees of Polymerisation (DP). Maltodextrins can include glucose (referred to herein as a DP1 sugar as it is a monosaccharide), maltose, (hereinafter referred to as a DP2 sugar as it is a disaccharide), malto-triose (hereinafter referred to as a DP3 oligosaccharide as it is a tri-saccharide) and oligosaccharides having four or more saccharide molecules (DP4+). As lactose is a disaccharide (DP2), its hydrolysis results in equal amounts of glucose and galactose (both DP1 sugars). Other DP2 sugars that can be included in the carbohydrate component of the milk products described herein include sucrose and di-fructose which are both disaccharides. The established carbohydrate polymer nomenclature is summarised by Cummings and Stephen as follows: DP1 and DP2 carbohydrates are sugars, DP3-DP9 carbohydrates are oligosaccharides and polymers of greater than DP10 are polysaccharides (Cummings and Stephen (2007) Carbohydrate terminology and classification European Journal of Clinical Nutrition Supplement 1, S5-S18).

The total amount of DP1 sugar (selected from glucose, galactose, fructose or a combination thereof) present in the milk products described herein is 3.0-18.0% w/w of the total carbohydrate component. The total amount of DP2 sugar (selected from maltose, lactose, sucrose, di-fructose or a combination thereof) present in the milk products described herein is 2.0-40.0% w/w of the total carbohydrate component. The total amount of DP3 oligosaccharide present in the milk products described herein (which can be provided by one or more digestible polysaccharide hydrolysates which include dextrins, maltodextrins, malto-triose, glucose syrups, polyfructose, fructose syrups, or a combination thereof) is 6.0-26.0% w/w of the total carbohydrate component.

The total amount of DP1 sugar in the milk products described herein can also be expressed in terms of mass per unit volume, such as between 0.18-1.00 g/100 mL in aqueous skim milk product containing 10.0% w/w of total solids. The total amount of DP2 sugar can be between 0.13-2.20 g/100 mL in aqueous skim milk product containing 10.0% w/w of total solids.

In the milk products described herein, the reactivity of the milk protein is effectively uniform due to its uniform source and processing steps, but the reactivity of one or more of the digestible polysaccharide hydrolysates is variable according to the composition of the carbohydrate component selected to replace the lactose.

Digestible polysaccharide hydrolysates such as maltodextrins are commercially characterised by their Dextrose Equivalence (DE) which is a measure of the reducing sugar content of the carbohydrate material and may be more precisely defined chemically by quantifying the individual mono-, di-,tri- and higher saccharides by a well-established method such as HPLC. The DE may also be available from the supplier or can be determined by redox titration. Table 1a below provides the theoretical and observed DE values for glucose polymers as disclosed in in the brochure “Nutritive Sweeteners From Corn” published by the US Corn Refiners Association (2006), Table III, page 31.

TABLE 1a
Theoretical and observed DE values for glucose polymers
as summarised in the brochure “Nutritive Sweeteners
From Corn” published by the US Corn Refiners Association
(2006), Table III, page 31 and reproduced here as Table 1a

| | Theoretical | Observed |
|---|---|---|
| | Dextrose | Dextrose |
| Carbohydrate | Equivalence | Equivalence* |
| Monosaccharide | 100.0 | 100.0 |
| Disaccharide | 52.6 | 58.0 |
| Trisaccharide | 35.7 | 39.5 |
| Tetrasaccharide | 27.0 | 29.8 |
| Pentasaccharide | 21.7 | 24.2 |
| Hexasaccharide | 18.2 | 20.8 |

*Determined by Corn Refiners Association Analytical Method E-26

The milk products described herein can include one or more digestible polysaccharide hydrolysates that have a DE of 8 to 43, more specifically a DE of 8-41, even more specifically a DE of 8-31, even more specifically a DE of 15-31 and even more specifically a DE of 28-3 land even more specifically a DE of 17-20.

The source of the digestible polysaccharide hydrolysate can for example be corn, rice or any other hypoallergenic vegetable material source. Preferably, the digestible polysaccharide hydrolysate is selected from a range of commercially available starch hydrolysate materials including dextrins, maltodextrins, glucose syrups and sugars as described by Sun et al (2010) (Sun J., Zhao R, Zeng J, Li G. and Li X. (2010) Characterisation of Dextrins with Different Dextrose Equivalents (DE). Molecules. 15, 5162-5173). Preferably, the digestible polysaccharide hydrolysate is a maltodextrin. The US Food and Drug Administration (US FDA) defines maltodextrins as non-sweet, nutritive saccharide polymers that have an average DE of less than 20, and nutritive saccharide polymers in which the average reducing sugar content is 20 DE or higher are defined as dried glucose syrups. The term maltodextrin as used herein is to be understood as dried nutritive saccharide oligomers or polymers with DE values of between 8 and 43. Dried glucose syrups with a DE higher than 43 are more difficult to manufacture due to their enhanced hygroscopicity and are therefore more expensive and difficult to handle, especially in dry products.

The DP1, DP2, DP3 and DP4+ carbohydrates are the major contributors to the sweetness of the milk products described herein. Table 2 below shows the sweetness of various carbohydrates relative to the sweetness of sucrose as provided in the document entitled “Relative Sweetness Values for Various Sweeteners” that is available at: http://owlsoft.com/pdf_docs/WhitePaper/Rel_Sweet.pdf. Accordingly, glucose has 74% of the sweetness of sucrose on a wt/wt basis. Digestible polysaccharide hydrolysates of defined sweetness and composition, other than those listed in Table 2, can also be included in the carbohydrate component of the milk products described herein.

TABLE 2
Relative Sweetness Factors of Selected Digestible Carbohydrates

| | Relative Sweetness Factors |
|---|---|
| Carbohydrate Name | (% sucrose sweetness) |
| Glucose | 74 |
| Lactose | 16 |
| Hydrolysed Lactose | 65 |
| Maltose | 50 |
| Malto-triose | 30 |
| 36DE Corn Syrup | 30-40 |
| (glucose syrup) | |
| 25DE Corn Syrup solids | 28 |
| (dried glucose syrup) | |
| 18DE Maltodextrin | 21 |
| 15DE Maltodextrin | 17 |
| 10DE Maltodextrin | 11 |

Inasmuch that a DP3 sugar such as malto-triose contributes less to the overall sweetness of the milk product due to its lower Relative Sweetness Value (Table 2), so too it contributes less to the reducing potential of the carbohydrate component relative to its mass when compared to the reducing potential of the DP1 sugar(s) and the DP2 sugar(s) (FIG. 1).

The type and quantity of the selected carbohydrate ingredients of the carbohydrate component is determined and calculated to be such that, when added to the quantity of residual carbohydrate that may be present as hydrolysed lactose in the milk protein source or in any dairy derived mineral source (and possibly any fat source), the total carbohydrate content of the milk product is equivalent or similar to that of the skim or fat-containing natural dairy milk product.

The potency of the combined mass and reducing properties of the carbohydrate component of the milk product to react with the concentrated milk protein component is described herein as the Reductive Carbohydrate (RC). The RC is defined as the product of the DE of the carbohydrate component (which is dimensionless) and the mass of the carbohydrate component (which can be expressed as unit of mass such as grams or a unit of mass per volume such as grams/100 mL) as indicated in Formula (I) below.

RC=DE*[carbohydrate]. (I)
wherein:
DE=Dextrose Equivalence
[carbohydrate]=mass of carbohydrate

Accordingly, the RC has the dimensions of mass. The RC indicates the potential of each monosaccharide (DP1 sugar), disaccharide (DP2 sugar) and tri-saccharide (DP3 oligosaccharide) present in the carbohydrate component of the milk product to react with the lysine residues of the milk protein component in the milk product via Maillard reactions that contribute to browning during thermal processing. All of the DP1, DP2, DP3 and DP4+ carbohydrates present in maltodextrins, for example, are reducing saccharides to some extent according to the DP as each sugar or oligosaccharide has a terminal aldehydic reducing moiety.

The RC of the milk product can be obtained by summing the RC for the DP1 sugar, DP2 sugar and DP3 oligosaccharide present in the milk product as follows:

### RC of DP1=DE (of DP1)*mass (of DP1);

### RC of DP2=DE (of DP3)*mass (of DP2);

### RC of DP3=DE (of DP3)*mass (of DP3);

and,
RC(of the milk product)=RC(DP1)+RC(DP2)+RC(DP3).

Although oligosaccharides of DP4+ may be present in the milk products described herein the reductive potential per unit mass of carbohydrate decreases with increasing DP. Accordingly, the RC is limited to the summation of RC values for DP1 to DP3. Further, the mass sums of DP1+DP2+DP3 may not total 100 as the sum does not take into account the mass of DP4 + oligosaccharides present.

The RC (of the milk product) can then be divided by the mass of the milk protein present in the concentrated milk protein component to obtain the reductive carbohydrate to milk protein mass ratio. As the mass of the milk protein can be expressed as unit of mass such as grams or a unit of mass per volume such as grams/100 mL, the reductive carbohydrate (DP1+DP2+DP3) to milk protein ratio is dimensionless. The reductive carbohydrate (DP1+DP2+DP3) to milk protein ratio of the milk products described herein can be any number included in the range of 10.0-70.0, more specifically, any number included in the range of 12.0-64.0, even more specifically, any number in the range of 19.0-50.0; even more specifically, any number in the range of 32.0-60.0, even more specifically, any number in the range of 35.0-50.0. Surprisingly, the inventors found that by preparing milk products with such ratios, many of the milk products did not exhibit browning upon thermal processing despite the total mass of the DP1 sugar being greater than the total mass of the DP2 sugar on a dry solids basis. The total mass of the DP1 sugar(s) on a dry solids basis can be greater than the total mass of the DP2 sugar(s) on a dry solids basis by a factor that is any number that falls in the numerical range of 1.05 to 5.00. Accordingly, the total mass of the DP1 sugar(s) can be greater than the total mass of DP2 sugar(s) by a factor of 1.05, 1.10, 1.15, 1.20, 1.25, 1.30, 1.35, 1.40, 1.45, 1.50, 1.55, 1.60, 1.65, 1.70, 1.75, 1.80, 1.85, 1.90, 1.95, 2.00, 2.05, 2.10, 2.15, 2.20, 2.25, 2.30, 2.35, 2.40, 2.45, 2.50, 2.55, 2.60, 2.65, 2.70, 2.75, 2.80, 2.85, 2.90, 2.95, 3.00, 3.05, 3.10, 3.15, 3.20, 3.25, 3.30, 3.35, 3.40, 3.45, 3.50, 3.55, 3.60, 3.65, 3.70, 3.75, 3.80, 3.85, 3.90, 3.95, 4.00, 4.05, 4.10, 4.15, 4.20, 4.25, 4.30, 4.35, 4.40, 4.45, 4.50, 4.55, 4.60, 4.65, 4.70, 4.75, 4.80, 4.85, 4.90, 4.95, 5.00. Specifically, the total mass of the DP1 sugar(s) can be greater than the total mass of the DP2 sugar(s) by a factor of 1.25 to 4.25, more specifically, 1.35 to 3.50, even more specifically 1.40 to 2.65, and even more specifically 1.45 to 1.75.

The milk products described herein can also be characterised by the reductive carbohydrate (RC) of the DP1 sugar and the DP2 sugar divided by the mass of the milk protein present as follows:

### RC of DP1=DE (of DP1)*mass (of DP1);

### RC of DP2=DE (of DP3)*mass (of DP2)

and,
RC(DP1+DP2)/milk protein=RC(DP1)+RC(DP2)/mass of the milk protein

The RC(DP1+DP2) to mass of the milk protein ratio of the milk products described herein can be any number included in the range of 7.0-56.0, more specifically, any number included in the range of 13.0-51.0, even more specifically, any number in the range of 23.0-51.0; even more specifically, any number in the range of 23.0-44.0, even more specifically, any number in the range of 28.0-44.0.

The milk products described herein can also be characterised by the ratio of the sum of the masses of the DP1 sugar, DP2 sugar and DP3 oligosaccharide to the mass of the milk protein present as follows:

[mass (of DP1)+mass (of DP2)+mass (of DP3)]/mass of milk protein

The mass (DP1+DP2+DP3) to mass of milk protein ratio of the milk products described herein can be any number included in the range of 0.20-1.15, more specifically, any number included in the range of 0.30-0.75, even more specifically, any number in the range of 0.40-0.75.

The milk products described herein can also be characterised by the ratio of the sum of the masses of the DP1 sugar and DP2 sugar to the mass of the milk protein present as follows:

[mass (of DP1)+mass (of DP2)]/mass of milk protein

The mass (DP1+DP2) to mass of milk protein ratio of the milk products described herein can be any number included in the range of 0.08-0.80, more specifically, any number included in the range of 0.30-0.75, even more specifically, any number in the range of 0.15-0.75.

The lactose-free milk products described herein are suitable for people with different dietary or organoleptic preference according to the quantity and type of fat contained in the product. The lactose-free milk products described herein can enable isotonic or hypotonic feeding which can improve availability of nutrition from the milk product. It is noted that normal serum osmolality is 275-295 mOsmol/kg (see Mendez et al 2015 FASEB Journal 29 1 supplement 583.1). The lactose-free milk products described herein can have an osmolality of 170-295 mOsmoles/kg. In the case of a skim milk product as described herein that contains dairy derived minerals, the product can have an osmolality of 170-250 mOsmoles/kg, more specifically 173-243 mOsmoles/kg, and even more specifically 173-209 mOsmoles/kg. The osmolality of a skim milk product as described herein that contains non-dairy derived minerals can be 185-295 mOsmoles/kg, more specifically 191-273 mOsmoles/kg and even more specifically 197-230 mOsmoles/kg.

The lactose-free milk product as described herein can be in dried powder form and may be equivalent in dairy fat-content to a whole milk powder (WMP) or the fat content may be greater or less. A lactose-free skim milk product as described herein may be in powder form and may be equivalent in dairy fat-content to skim milk powder (SMP). If the milk product includes fat, the fat may be in the form of lactose-free cream or anhydrous lactose-free milk fat, either of which is obtained from the milk of a domesticated mammal, for example, such as cow, sheep, buffalo, camel, llama, reindeer, horse, yak or goat. The fat in the milk products described herein may also be obtained from a suitable animal or a vegetable source. A milk product as described herein is considered to be a dry powder if the product has 0-10.0% w/w moisture content, more specifically 0-6.0% w/w moisture content.

The lactose-free milk products described herein can also be a liquid (at a temperature, for example, of 5-25° C.) such as beverages or yoghurts, a solid such as ice-cream or frozen yoghurt (at a temperature for example, below 5° C.) or a concentrated milk product (at a temperature, for example, of 5-25° C.). A milk product as described herein is considered to be concentrated if the product (excluding the fat content) has between 15.0-85.0% w/w water.

The lactose-free milk products described herein have similar physical and functional characteristics to natural dairy milk products, such as flavour, colour, solubility, viscosity, freezing point and emulsification.

### Preparation of Lactose-Free Skim Milk Products

A lactose-free skim milk product is prepared as a liquid, a liquid concentrate or a dry powder suitable for reconstitution. For the preparation of such lactose-free skim milk powder product (LF-SMP), the ratio of total digestible carbohydrate to milk protein is preferably comparable to that in full-lactose skim milk powder (SMP) to provide a suitable nutritional balance for adult consumers. The viscosity of such a skim milk product when reconstituted from the lactose-free powder product is such that it is comparable to that of skim milk at the same temperature and solids content.

A quantity of lactose-free concentrated milk protein as either milk protein concentrate (MPC), microfiltered milk protein concentrate (MMPC) or milk protein isolate (MPI) is added to one or more digestible polysaccharide hydrolysates and a quantity of minerals. The concentrated milk protein can be produced by filtration techniques to provide concentrated milk protein that contains less than 15.0% w/w lactose and preferably less than 10.0% w/w on a dry solids basis. Preferably such protein-enriched product contains greater than 80.0% w/w protein on a dry solids basis.

MPI can be produced by diafiltration of MPC with water or suitable non-lactose-containing aqueous solvent to provide a protein-enriched product that contains less than 3.0% w/w lactose on a dry solids basis and preferably greater than 90.0% w/w protein on a dry solids basis. The MPC, MMPC or MPI may be additionally modified to achieve particular attributes, for example, by processes to adjust the mineral content such as cation exchange to modify the divalent calcium and magnesium ion contents.

To provide a suitable mineral balance in the lactose-free skim milk product, it is acceptable to use non-dairy minerals as suitable inorganic food-grade chemicals. Alternatively, dairy-derived minerals from mineral-rich co-product concentrates that arise from membrane or chromatographic processing of milk or whey may also be used as the mineral source. Such concentrates are treated with lactase enzyme in an amount and under conditions as aforesaid to hydrolyse residual lactose and render them lactose-free. The content of galactose and glucose in the lactose-free mineral concentrates is determined by any suitable method preferably by HPLC as a measure of the sweetness and DE. The carbohydrate component in the skim milk product arises from the lactose hydrolysis, the one or more digestible polysaccharide hydrolysates as well as the carbohydrate that is present in the milk protein component and any dairy derived minerals.

To achieve a lactose-free composition, residual lactose in the component dairy derived components is hydrolysed with lactase enzyme to yield monosaccharides. For example, commercial lactase is added to liquid MPC, MMPC or MPI at a temperature in the range of 0 to 40° C., and preferably in the range 2 to 10° C. to minimise bacterial growth. An amount of lactase relative to the lactose content is added as recommended by the enzyme supplier for a time period for the lactose content to sufficiently diminish to obtain a lactose-free state. The content of galactose and glucose in the lactose-free MPC, MMPC or MPI is determined by any suitable means, preferably by HPLC as a measure of the sweetness and DE.

The hydrolysis products of lactose (namely glucose and galactose) are much sweeter than lactose at the same concentration. The sweetness of the lactose-derived monosaccharides together with that of the maltose and glucose from the selected digestible polysaccharide hydrolysates combine additively to provide the total sweetness of the whole composition. It is, therefore, technically challenging to predict flavour outcomes of different lactose-free compositions. For instance, maltodextrins of different sugar contributions or milk protein fractions that contain low molecular weight intensively flavoured components such as minerals and non-protein nitrogenous compounds can alter the flavour of the milk product.

The non-dairy, digestible polysaccharide hydrolysate to provide the required contribution to the composition and sweetness may be a single dextrin material of designated DE and sugar content (for example, DP1 and DP2 sugar content). Alternatively, it may be a mixture of two or more digestible polysaccharide hydrolysates having different DE and sugar content values that together in appropriate proportions will provide the required sweetness contribution, DE and sugar content.

While as aforesaid it is principally the monosaccharide and disaccharide content of the polysaccharide hydrolysate that provides the sweetness and DE, it has been discovered by the inventors that larger saccharide oligomers and polysaccharides may contribute adversely to the viscosity and mouthfeel of the lactose-free skim milk product. It is therefore necessary to select one or more digestible polysaccharide hydrolysates that not only provide the required sweetness and DE, but also the desirable viscosity and organoleptic properties.

The selected polysaccharide hydrolysate(s) is preferably dispersed in a quantity of water sufficient to facilitate mixing it with aqueous dispersions of the other components of the lactose-free skim milk product. Alternatively, the polysaccharide hydrolysate(s) is added in dry form with vigorous mixing to the aqueous dispersions of the other components. Optionally, other nutrient materials such as vitamins, trace elements, nutritional co-factors, colourants and flavourants can be added to the aqueous mix of the selected components. Additional materials to enhance the desirability of the lactose-free skim milk product may also be added.

Alternatively, all the dairy derived components of the lactose-free skim milk product (milk protein and/or dairy derived minerals) may be combined without prior treatment with lactase enzyme and subsequently the combined ingredients are treated with lactase as aforesaid to provide a lactose-free skim milk product. The content of galactose and glucose in the lactose-free combined dairy components is determined by any suitable method preferably by HPLC as a measure of the sweetness and DE. To this combined lactose-free dairy component mix is added the selected digestible polysaccharide hydrolysate.

Alternatively, if the lactose content of the dairy derived components is precisely determined so that the content of galactose and glucose arising from lactase enzyme hydrolysis of the lactose is predicted, and the quantity and type of non-lactose carbohydrate can be predicted, then a mix containing all the dairy and non-dairy ingredients can be lactase treated in combined form to provide a lactose-free skim milk product.

The aqueous mix of the selected lactose-free components can be pasteurised or otherwise heat-treated to ensure a sanitary product, homogenised to ensure uniform distribution, concentrated by evaporation and dried using standard dairy manufacturing methods and facilities. Optionally the evaporated concentrate may be dried in a multi-stage process as standard procedure in the dairy industry such that the powder product is in an agglomerated form.

From a consumer-acceptability/food-manufacturer-utility aspect, the lactose-free skim milk products described herein should have similar colour, flavour, odour and mouthfeel/texture comparable to natural milk products together with similar ease of use, shelf stability and useability properties. For food manufacturing, functional properties including solubility, dispersability, emulsification, foaming, viscosity, hygroscopicity, and susceptibility to browning during heat processing need to be comparable to those of natural dairy milk and milk products.

### Preparation of Lactose-Free Fat-Containing Milk Products

A lactose-free fat-containing milk product is prepared as a liquid, a liquid concentrate or a dry powder (lactose-free fat-containing dairy milk powder (FDP)) that is suitable for reconstitution. For the preparation of such lactose-free fat-containing dairy milk product, the ratio of milk protein to digestible carbohydrate is preferably comparable to that in both whole milk powder and skim milk powder to provide a suitable nutritional balance for consumers. The viscosity of such lactose-free fat-containing dairy milk product when reconstituted from the lactose-free product powder is such that it is comparable to that of natural milk with the same fat content at the same temperature and solids content.

Typically, fat-containing dairy milk has a recognisable flavour and sweetness that is predominantly a consequence of the content of fat and lactose. This content of digestible carbohydrate and sweetness is provided similarly in the lactose-free fat-containing milk products described herein. Creamy texture is also provided by the significant emulsified fat content.

A quantity of lactose-free concentrated milk protein as milk protein concentrate (MPC) or milk protein isolate (MPI) or microfiltered milk protein concentrate (MMPC) product is produced as aforesaid and the content of residual hydrolysed lactose determined as the reducing sugars, galactose and glucose.

An appropriate quantity of one or more lactose-free food grade or dairy mineral concentrates as aforesaid is selected to provide the desired content of particular elements and the content of residual hydrolysed lactose is determined as the reducing sugars, galactose and glucose.

An appropriate quantity of lactose-free cream is selected according to the fat content of the cream and the desired fat content of the lactose-free fat-containing milk product that is required. The content of residual hydrolysed lactose is determined as the reducing sugars, galactose and glucose.

The combined contributions to the carbohydrate content, sweetness and DE of the lactose-free milk product from the milk-derived components are provided by the total content of each of galactose and glucose. As a benchmark figure, SMP has a sweetness value of 8.5 according to Table 2 calculated according to (sweetness of lactose value, 16)×(proportion of composition provided by lactose, 0.53) calculated on a dry basis.

The residual lactose of dairy derived components such as milk mineral concentrates, cream and milk protein concentrates, when hydrolysed, can be used to contribute to sweetness and other functional properties in the lactose-free milk product. A carbohydrate composition that has a higher proportion of monosaccharide than disaccharide can be utilised and can replace lactose to prepare lactose-free milk products with acceptable taste, appearance and functionality. Furthermore, it has been discovered that hydrolysed lactose from cream and milk mineral concentrates can allow the use of lower DE maltodextrins to be used in lactose-free fat containing milk products, which is advantageous in terms of both cost and manufacturability.

To prepare a lactose-free milk product that contains fat, it is preferred that dairy fat in the form of dairy cream is selected as a component of the composition. Such dairy cream may differ greatly in fat content and consequently in lactose content. This dairy cream is rendered lactose-free by addition of lactase enzyme in an amount and under conditions as aforesaid before addition to the aqueous mix of other components. As dairy cream contains lactose, the lactose-hydrolysed cream that is added contributes to the sweetness and monosaccharide (DP1) content of the lactose-free fat containing milk product. The content of galactose and glucose in the lactose-free cream is determined by any suitable method preferably by HPLC as a measure of the sweetness and DE.

Optionally, dairy fat as anhydrous milk fat or another fat or oil of animal or vegetable origin is selected and is added to the aqueous mix of selected components.

The non-dairy carbohydrate ingredient to provide the required contribution to the composition and sweetness may be a single digestible polysaccharide hydrolysate of designated DE if the composition is such that the required quantity of carbohydrate delivers the required amount of sweetness. Alternatively, it may be a mixture of two or more digestible polysaccharide hydrolysates having different DE values that together in appropriate proportions will provide the required sweetness and DE contribution from the required carbohydrate contribution. While as aforesaid it is principally the monosaccharide and disaccharide content of the digestible polysaccharide hydrolysate(s) that provide the sweetness, larger saccharide oligomers in the polysaccharide hydrolysate may contribute adversely to the viscosity and mouthfeel of the lactose-free fat containing milk product. The polysaccharide hydrolysates should not only provide the required sweetness and DE, but also the desirable viscosity and organoleptic properties.

The quantities of lactose-free MPC, MMPC or MPI, lactose-free minerals, lactose-free cream and the required quantity of the selected digestible polysaccharide hydrolysate, preferably in concentrated aqueous dispersion, are combined. Alternatively, the dry components are dispersed in the liquid components to minimise water in the composition and thereby improve the efficiency of further processing steps such as but not limited to homogenisation, pasteurisation, evaporation and drying.

Additional nutrient materials and materials to enhance the desirability of the lactose-free fat-containing milk product as aforesaid can also be added.

The aqueous mix of the selected lactose-free components is pasteurised or otherwise heat treated, homogenised, concentrated by evaporation and dried as aforesaid using standard dairy manufacturing methods and facilities.

As the carbohydrate to protein ratio in the lactose-free fat-containing milk product is the same as in SMP, on a non-fat basis, an efficiency of production of about 100% is achieved based on milk protein supplied relative to potential yield as SMP. Actual product yield is greater due to the additional fat.

The following non-limiting examples further describe the milk products of the invention and it is to be understood that modifications and/or alterations of the examples, which would be apparent to a person skilled in the art based upon the disclosure herein, are also considered to fall within the scope and spirit of the invention, as defined in the appended claims.

### EXAMPLE 1—Laboratory-Scale Preparation of Liquid Lactose-Free Skim Milk Products with Nutritional Balance Comparable to Skim Milk in Order to Identify Suitable Digestible Polysaccharide Hydrolysates for Lactose Replacement when Dairy-Derived Minerals are included

For industrial relevance, commercial dairy materials were sourced from a modern dairy plant that routinely produced milk protein concentrates (MPC) and isolates from milk using membrane technology, and recovered mineral components, lactose and other milk fractions with a range of technologies. All dairy ingredients were obtained with compositional analysis undertaken by the dairy plant laboratory. The analytical details are provided in Table 3.

TABLE 3
Compositions of dairy ingredients

| Dairy Ingredient | Moisture % | Protein % | Fat % | Carbohydrate % | Ash % | Total solids % |
|---|---|---|---|---|---|---|
| MPC-85 | 4.8 | 85 | 1.2 | 3.5 | 6.8 | 95.2 |
| Mineral Powder | 4.5 | 15 | 3 | 44 | 33.5 | 96.5 |
| Mineral Concentrate | 63.1 | 6.5 | 0.1 | 6.3 | 24 | 36.8 |
| Cream | 49.2 | 1.5 | 47.1 | 1.6 | 0.55 | 50.8 |

Digestible polysaccharide hydrolysates prepared by partial enzymatic hydrolysis of corn starch were obtained as maltodextrins from several commercial suppliers covering a wide range of Dextrose Equivalence.

To evaluate the suitability of each of the available maltodextrin products for replacement of lactose in lactose-free skim milk product, small batches of skim milk products were prepared using aliquots of blended dairy ingredients from those listed in Table 3 to which was added the same quantity of one of the maltodextrins that were tested.

The skim milk products of Example 1 had the composition, expressed as g/100 g of mixture, as shown in Table 4.

TABLE 4
Composition of skim milk products of Example 1

| | Amount |
|---|---|
| Ingredient | (g/100 g) |
| MPC-85 | 3.90 |
| Mineral Powder | 0.73 |
| Mineral Concentrate | 1.02 |
| Maltodextrin | 5.02 |
| (various) | |
| Water | 89.35 |

### Preparation of Skim Milk Compositions

MPC-85 (43 g) and commercially available milk-derived mineral powder (8 g) and mineral concentrate (11 g) were mixed into water (985 g) and stirred until completely dispersed to produce a dairy ingredient blend. To an aliquot (95 g) of the dairy ingredient blend was added maltodextrin (5 g) with vigorous stirring. To each thoroughly dispersed mixture was added lactase enzyme (15 microL, GODO YNL2 yeast lactase) and incubated overnight at 8° C. Samples were heated to 65° C. for 10 minutes and cooled rapidly to ambient temperature to deactivate the lactase and sanitise the products.

Additional control samples were prepared as follows:
(1) a batch that did not include maltodextrin and that was not treated with lactase; 1(vii);
(2) a batch that included a carbohydrate component of maltodextrin having a DE of 40-43 and lactose was prepared by blending the maltodextrin and lactose to approximate the case where MPC80 provided the milk protein content with a greater lactose content and digestible polysaccharide hydrolysate containing predominantly DP2 (maltose) was used to more closely replicate the carbohydrate content of regular milk; the batch was treated with lactase to produce a lactose-free skim milk product;

1(viii)
(3) a batch of commercial skim milk powder was prepared at the same total solids concentration as the skim milk compositions 1(i) to 1(vi) and the batch was treated with lactase to produce a lactose reduced skim milk product; 1(ix).

In order to characterise the carbohydrate content of the lactose-free skim milk compositions, portions of all compositions were precipitated with an equal volume of 100% isopropanol and centrifuged at 12000 rpm for 1 minute to remove any sediment and portions of the clarified supernatants were further diluted ⅕ with 0.4% orthophosphoric acid and microfiltered prior to injection onto the HPLC column. The resulting dilution of the sample was 1/10.

Detailed analyses of the DP1 sugar, DP2 sugar, DP3 oligosaccharide and larger DP4+ oligosaccharides of each of the compositions was undertaken by HPLC using a ResEx RHM H+ Monosaccharide chromatography column with 0.4% (v/v) orthophosphoric acid as eluent operating at 30° C. and a refractive index detector. The extinction coefficient for 1 g/L maltose (DP2) was 56260, 1 g/L glucose (DP1) 58470 and for 1 g/L galactose (also DP1) 56713. The extinction coefficient for malto-triose (DP3) was not measured, but assumed to be the same as maltose on the basis that there was very little difference between the DP1 and DP2 extinction coefficients that were measured. The calculation of the DP4+ fraction was limited by the capacity of the column, so the mass balance, where necessary was adjusted to full mass recovery by adjusting the DP4+ fraction. The carbohydrate components of the skim milk products are provided in Table 5. It will be appreciated that the DP1 and DP2 sugars in Examples 1(i) to 1(vi) and 1(viii) in Table 5 below arise from the hydrolysis of lactose and the dairy-derived minerals as well as the DP1 and DP2 sugar content in the added maltodextrin. The oligosaccharides DP3 and DP4+ present in Examples 1(i) to 1(vi), 1(viii) arise from the added maltodextrin.

TABLE 5
Principle component composition of different skim milk products of Example
1. Carbohydrate component contents as determined by HPLC analysis. (Note:
the values provided in Table 5 are g/100 mL of undiluted liquid skim
milk product unless indicated as grams on a dry solids basis).

| | Example | | | | | | | | |
|---|---|---|---|---|---|---|---|---|---|
| | | | | | | | 1(vii) | 1(viii) | 1(ix) |
| | 1(i) | 1(ii) | 1(iii) | 1(iv) | 1(v) | 1(vi) | Control | Control | Control |
| | MD | | | | | | | | |
| | | | | | | | | DE | Reconstituted |
| | | | | | | | | 40-43*** | commercial |
| | DE | DE | DE | DE* | DE* | DE | | lactose | skim milk |
| | 8-10 | 10-12 | 17-20 | 28-31 | 28-31 | 37-41 | No MD** | blend | powder |
| Milk Protein | 3.50 | 3.50 | 3.50 | 3.50 | 3.50 | 3.50 | 3.68 | 3.50 | 3.50 |
| DP4+ | 3.85 | 3.86 | 3.62 | 2.89 | 2.74 | 1.39 | 0 | 0.68 | 0.08 |
| DP3 | 0.35 | 0.35 | 0.49 | 0.80 | 0.55 | 1.24 | 0 | 0.97 | 0.20 |
| DP2 | 0.29 | 0.24 | 0.33 | 0.65 | 1.16 | 1.71 | 0.55 | 1.86 | 0.63 |
| DP1 (Total) | 0.81 | 0.85 | 0.87 | 0.96 | 0.85 | 0.96 | 0 | 1.80 | 4.50 |
| Glu (Total) | 0.45 | 0.48 | 0.51 | 0.60 | 0.50 | 0.60 | 0 | 1.07 | 2.25 |
| Glu (from | 0.09 | 0.11 | 0.15 | 0.23 | 0.15 | 0.24 | 0 | 0.34 | 0 |
| MD) | | | | | | | | | |
| Glu (from | 0.36 | 0.37 | 0.36 | 0.37 | 0.35 | 0.36 | 0 | 0.73 | 2.25 |
| lactose) | | | | | | | | | |
| Gal (from | 0.36 | 0.37 | 0.36 | 0.37 | 0.35 | 0.36 | 0 | 0.73 | 2.25 |
| lactose) | | | | | | | | | |
| Total | 5.30 | 5.30 | 5.30 | 5.30 | 5.30 | 5.30 | 0.55 | 5.31 | 5.41 |
| carbohydrate | | | | | | | | | |
| DP4+ dsb (g) | 40.06 | 40.17 | 37.64 | 30.07 | 28.51 | 14.46 | 0 | 7.08 | 0.88 |
| DP3 dsb (g) | 3.65 | 3.65 | 5.12 | 8.32 | 5.69 | 12.87 | 0 | 10.14 | 2.06 |
| DP2 dsb (g) | 3.00 | 2.54 | 3.40 | 6.72 | 12.10 | 17.83 | 11.30 | 19.33 | 6.56 |
| DP1 dsb (g) | 8.44 | 8.84 | 9.02 | 10.04 | 8.89 | 9.97 | 0 | 18.68 | 46.82 |

Glu = glucose
Gal = galactose
dsb = dry solids basis
DE = Dextrose Equivalence of the maltodextrin tested
MD = maltodextrin
DP1 = Degree of polymerisation of the sugar is 1, specifically galactose and glucose
DP2 = Degree of polymerisation of the sugar is 2, specifically maltose
DP3 = Degree of polymerisation of the oligosaccharide is 3, specifically maltotriose
DP4+ Degree of polymerisation of the oligosaccharide is 4 or greater
*Two different commercial DE 28-31 products which differed in proportions of DP1 and DP2 were used.
**Control sample that lacked maltodextrin and lactase treatment.
***The added carbohydrate comprised 86% of DE 40-43 maltodextrin and 14% of lactose. In this control, MPC-80 provided the milk protein content and the digestible polysaccharide hydrolysate containing predominantly DP2 (maltose) was used to more closely replicate the carbohydrate content of regular milk. The composition was treated with lactase to produce a lactose-free product.

The calculated reductive carbohydrate to milk protein mass ratios of the milk products are provided in Table 6. By way of example, the RC(DP1+DP2+DP3) for Example 1(i) was calculated by using the observed DE values in Table 1a as follows:

RC(DP1+DP2+DP3)=[(0.81 g/100 mL (mass of D1 sugar)×100 (DE of DP1 sugar))+(0.29 g/100 mL (mass of DP2 sugar)×58 (DE of DP2 sugar))+(0.35 g/100 mL (mass of DP3 sugar)×39.5 (DE of DP3 sugar))]=(81+16.8+13.8)=111.6 g/100 mL

The RC to milk protein mass ratio for Example 1(i) is then calculated by dividing the total RC by the mass of the milk protein present in Example 1(i) as follows:

(111.6 g/100 mL)/3.5 g/100 mL=31.9.

As oligosaccharides of DP4+ may be present in the milk products described herein the mass sums of DP1+DP2+DP3 may not total 100. The reason that DP4+ is not included in the calculation of the RC to milk protein mass ratio is that the effect of DP4+ oligosaccharides on the nutritional, organoleptic and functional properties of the milk products is considered minimal when compared to the effect of the DP1, DP2 and DP3 sugar present.

TABLE 6
Calculation of sugar to milk protein ratio and RC to milk
protein ratio using the HPLC data provided in Table 5.

| | Example | | | | | | | | |
|---|---|---|---|---|---|---|---|---|---|
| | | | | | | | 1(vii) | 1(viii) | 1(ix) |
| | 1(i) | 1(ii) | 1(iii) | 1(iv) | 1(v) | 1(vi) | Control | Control | Control |
| | MD | | | | | | | | |
| | | | | | | | | DE*** | Reconstituted |
| | | | | | | | | 40-43 | commercial |
| | DE | DE | DE | DE* | DE* | DE | | lactose | skim milk |
| | 8-10 | 10-12 | 17-20 | 28-31 | 28-31 | 37-41 | No MD** | blend | powder |
| DP1 % of total | 15.3 | 16.0 | 16.3 | 18.2 | 16.1 | 18.1 | 0 | 33.8 | 83.1 |
| carbohydrate | | | | | | | | | |
| DP1 to milk | 0.23 | 0.24 | 0.25 | 0.28 | 0.24 | 0.27 | 0 | 0.51 | 1.29 |
| protein mass ratio | | | | | | | | | |
| RC (DP1) value | 81 | 85 | 87 | 96 | 85 | 96 | 0 | 180 | 450 |
| RC (DP1) to milk | 23.2 | 24.3 | 24.8 | 27.6 | 24.4 | 27.4 | 0 | 51.3 | 128.6 |
| protein mass ratio | | | | | | | | | |
| DP2 % of total | 5.4 | 4.6 | 6.2 | 12.2 | 21.9 | 32.3 | 100.0 | 35.0 | 11.6 |
| carbohydrate | | | | | | | | | |
| DP2 to milk | 0.08 | 0.07 | 0.09 | 0.18 | 0.33 | 0.49 | 0.15 | 0.53 | 0.18 |
| protein mass ratio | | | | | | | | | |
| RC (DP2) value | 17 | 14 | 19 | 38 | 68 | 99 | 32 | 108 | 37 |
| RC (DP2) to milk | 4.8 | 4.1 | 5.4 | 10.7 | 19.3 | 28.4 | 8.7 | 30.8 | 10.4 |
| protein mass ratio | | | | | | | | | |
| DP3 % of total | 6.6 | 6.6 | 9.3 | 15.1 | 10.3 | 23.3 | 0 | 18.4 | 3.7 |
| carbohydrate | | | | | | | | | |
| DP3 to milk | 0.10 | 0.10 | 0.14 | 0.23 | 0.16 | 0.35 | 0 | 0.28 | 0.06 |
| protein mass ratio | | | | | | | | | |
| RC (DP3) value | 14 | 14 | 19 | 32 | 22 | 49 | 0 | 39 | 8 |
| RC (DP3) to milk | 4.0 | 4.0 | 5.5 | 9.0 | 6.2 | 14.0 | 0 | 11.0 | 2.2 |
| protein mass ratio | | | | | | | | | |
| Sugar (DP1 + DP2) | 0.31 | 0.31 | 0.34 | 0.46 | 0.58 | 0.76 | 0.15 | 1.04 | 1.47 |
| to milk protein | | | | | | | | | |
| mass ratio | | | | | | | | | |
| RC (DP1 + DP2) to | 28.0 | 28.3 | 30.2 | 38.3 | 43.7 | 55.8 | 8.74 | 82.1 | 139.0 |
| milk protein mass | | | | | | | | | |
| ratio | | | | | | | | | |
| (DP1 + DP2 + DP3) | 0.41 | 0.41 | 0.48 | 0.69 | 0.73 | 1.12 | 0.15 | 1.32 | 1.52 |
| to milk protein | | | | | | | | | |
| mass ratio | | | | | | | | | |
| RC | 31.9 | 32.3 | 35.7 | 47.3 | 49.8 | 69.7 | 8.7 | 93.1 | 141.2 |
| (DP1 + DP2 + DP3) | | | | | | | | | |
| to milk protein | | | | | | | | | |
| mass ratio | | | | | | | | | |

*Two different commercial DE 28-31 products which differed in proportions of DP1 (glucose) and DP2 (maltose) were used.
**Control sample that lacked maltodextrin and lactase treatment.
***The added carbohydrate comprised 86% of DE 40-43 maltodextrin and 14% of lactose. In this control, MPC-80 provided the milk protein content and digestible polysaccharide hydrolysate containing predominantly DP2 (maltose) was used to more closely replicate the carbohydrate content of regular milk. The composition was treated with lactase to produce a lactose-free product.

Expected sweetness values were calculated for Examples 1(i) to 1(ix) made with different maltodextrin products using Relative Sweetness Factors as provided in Table 2. Results are provided in Table 7.

Osmolality of Examples 1(i) to 1(ix) was determined, using a standard method entailing measurement of freezing point depression, for each milk product using the same clarified supernatant fractions used for HPLC analysis as aforesaid. Results are provided in Table 7.

Reactive lysine was determined by the method of Vigo et al (1992) using o-phthaldialdehyde to label the primary amine functional groups of exposed lysine chains which may be lost due to reaction with reducing sugar in a Maillard-type reaction during heating (see Vigo, M. S., Malec, L. S., Gomez, R. G. & Llosa, R. A. (1992) Spectrophotometric assay using o-phthaldialdehyde for determination of reactive lysine in dairy products. Journal of Agricultural & Food Chemistry 44, 363-365). The extent of browning was assessed visually against a white tile after heating each of the compositions under sterilising conditions in an autoclave at 121° C. for 15 minutes followed by rapid cooling to ambient temperature. Results are provided in Table 7.

TABLE 7
The extent to which different maltodextrins may affect organoleptic, nutritional
and appearance properties of the skim milk products of Example 1.

| | Example | | | | | | | | |
|---|---|---|---|---|---|---|---|---|---|
| | | | | | | | 1(vii) | 1(viii) | 1(ix) |
| | 1(i) | 1(ii) | 1(iii) | 1(iv) | 1(v) | 1(vi) | Control | Control | Control |
| | MD | | | | | | | | |
| | | | | | | | | DE*** | |
| | | | | | | | | 40-43 | Reconstituted |
| | | | | | | | No MD** | lactose | commercial |
| | | | | | | | (not | blend | skim milk |
| | | | | | | | treated | (treated | powder |
| | DE | DE | DE | DE* | DE* | DE | with | with | (treated with |
| | 8-10 | 10-12 | 17-20 | 28-31 | 28-31 | 37-41 | lactase) | lactase) | lactase) |
| Sugar | 0.31 | 0.31 | 0.34 | 0.46 | 0.58 | 0.76 | 0.15 | 1.04 | 1.47 |
| (DP1 + DP2) to | | | | | | | | | |
| milk protein | | | | | | | | | |
| mass ratio | | | | | | | | | |
| Sugar RC | 28.0 | 28.3 | 30.2 | 38.3 | 43.7 | 55.8 | 8.7 | 82.1 | 139.0 |
| (DP1 + DP2) to | | | | | | | | | |
| milk protein mass | | | | | | | | | |
| ratio | | | | | | | | | |
| DP1 + DP2 + DP3 to | 0.41 | 0.41 | 0.48 | 0.69 | 0.73 | 1.12 | 0.15 | 1.32 | 1.52 |
| milk protein mass | | | | | | | | | |
| ratio | | | | | | | | | |
| RC | 31.9 | 32.3 | 35.7 | 47.3 | 49.8 | 69.7 | 8.7 | 93.1 | 141.2 |
| (DP1 + DP2 + DP3) | | | | | | | | | |
| to milk protein | | | | | | | | | |
| mass ratio | | | | | | | | | |
| Calculated | 8.2 | 8.2 | 9.2 | 12.6 | 13.7 | 19.5 | 5.7 | 25.2 | 34.3 |
| sweetness | | | | | | | | | |
| Osmolality | 173 | 174 | 178 | 207 | 209 | 243 | 118 | 285 | 432 |
| mOsmoles/kg | | | | | | | | | |
| Reactive lysine | 94 | 93 | 97 | 95 | 94 | 95 | 100 | 91 | 80 |
| after heat | | | | | | | | | |
| treatment (% of | | | | | | | | | |
| control) **** | | | | | | | | | |
| Visual colour | no | no | no | no | no | slight | no | more | much more |
| assessment after | colour | colour | colour | colour | colour | brown | colour | brown | brown |
| heating | | | | | | colour | | colour | colour |

*Two different commercial DE 28-31 products which differed in proportions of DP1 and DP2 were used.
**Control sample that lacked maltodextrin and lactase treatment.
***The added carbohydrate comprised 86% of DE 40-43 maltodextrin and 14% of lactose. In this control, MPC-80 provided the milk protein content and digestible polysaccharide hydrolysate containing predominantly DP2 (maltose) was used to more closely replicate the carbohydrate content of regular milk. The composition was treated with lactase to produce a lactose-free product.
**** The reactive lysine result was standardised to the control milk product 1(vii) which did not contain added maltodextrin, hence the reactive lysine entry in Table 7 for 1 (vii) is 100.

From the results in Table 7, it was observed that the use of maltodextrins having a DE in the range of 8-41 in a milk product having a sugar (DP1+DP2) to protein ratio in the range 0.31-0.76 and a RC(DP1+DP2+DP3) to milk protein ratio in the range of 31.9-69.7 does not result in significant Maillard reaction in the lactose-free skim milk products labelled as 1(i) to 1(vi) as shown by the absence of significant browning after heat treatment of these milk products. This is remarkable considering that the carbohydrate fraction of these milk products contained from 15.3-18.1% DP1 sugar as shown in Table 6 without nutrition loss upon heat treatment as shown by the lack of lysine loss after heat treatment. This is surprising as a higher DP1 sugar content would reasonably be expected to increase susceptibility to nutrition loss upon heating, because the DP1 sugar would react with the lysine residues of the milk protein. Indeed, when the reduced lactose milk product 1(viii) was hydrolysed with lactase to yield a DP1 sugar content of 33.8% of total carbohydrate, unacceptable colour and reactive lysine loss was observed (see the results for 1(viii) in Table 7).

Milk products 1(i) to 1(vi) also surprisingly had flavour and sweetness (data not shown) comparable to reconstituted skim milk powder at the same total solids content (calculated sweetness value 8.5) despite the fact that the calculated sweetness values of these lactose-free milk products ranged from similar to more than twice as great (8.2-19.5) which suggests that other components of the composition affect the sensation of sweetness. Another unexpected result was that maltodextrins with low levels of maltose (denoted as DP2 in Tables 5-7 with the exception of example 1(vii) which was not treated with lactase) were acceptable in the milk products despite their stark difference to the physical and organoleptic properties of lactose.

Further, milk products 1(i) to 1(vi) surprisingly demonstrated an osmolality value that was less than half that for the lactose hydrolysed SMP control 1(ix) and significantly lower than regular skim milk (data not shown) which enables the potential for hypotonic feeding using the lactose-free skim milk products described herein with the same nutrition profile as regular skim milk.

Accordingly, a lactose-free, skim milk product (that contains milk protein and dairy-derived minerals and maltodextrin with a DE in the range of 8-41) that exhibits balanced sweetness and low browning during exposure to heat, can be prepared by ensuring that the RC(DP1+DP2+DP3) to milk protein mass ratio is in the range of 31.9-69.7, more specifically in the range of 31.9 to 49.8, and even more specifically in the range of 35.7 to 49.8 as can be seen in Example 1. Moreover, digestible polysaccharide hydrolysates such as maltodextrins having a DE of 8 to 41, more specifically a DE of 8-36, even more specifically a DE of 8-31, even more specifically a DE of 15-31, even more specifically a DE of 17-20 and even more specifically a DE of 28-31 have shown to be effective in preparing the lactose free skim milk products of Example 1.

### EXAMPLE 2—Laboratory-Scale Preparation of Liquid Lactose-Free Skim Milk Products with Nutritional Balance Comparable to Skim Milk in Order to Identify Suitable Digestible Polysaccharide Hydrolysates for Lactose Replacement when Non-Dairy Derived Minerals Supplied as Food Grade Chemicals are Used

Commercial milk protein concentrate as MPC-85 was sourced from a modern dairy plant as in Example 1 with compositional analysis as in Table 3.

Digestible starch hydrolysates were obtained as maltodextrins from commercial suppliers covering a range of Dextrose Equivalence as in Example 1.

To evaluate the suitability of each of the available maltodextrin products for replacement of lactose in lactose-free non-fat milk product in conjunction with food grade minerals, small batches of products were prepared as in Example 1 in which the minerals added were commercially supplied food grade chemicals instead of dairy derived minerals. Consequently, the mineral source for the products described in Example 2 does not include lactose.

On the basis of known concentrations of the principal mineral anions and cations in skim milk (see Canadian Dairy Commission available at: http://milkingredients.ca/index-eng.php), a mixture of inorganic chemicals was prepared as shown in Table 8.

TABLE 8
Mineral composition used in the preparation
of liquid lactose-free skim milk products

| | Quantity |
|---|---|
| Chemical component | (g) |
| Sodium dihydrogen phosphate | 15.3 |
| Dipotassium hydrogen phosphate | 22.1 |
| Sodium chloride | 14.0 |
| Potassium chloride | 44.4 |
| Total | 95.8 |

MPC-85 (45 g) and the mineral composition shown in Table 8 (5.95 g) were mixed into water (990 g) and stirred until completely dispersed. To an aliquot (95 g) of the ingredient blend was added maltodextrin (5 g) with vigorous stirring. To each thoroughly dispersed mix was added lactase enzyme (15 μL, GODO YNL2 yeast lactase) and incubated overnight at 2-8° C. As in Example 1, samples were heated to 65° C. for 10 minutes and cooled rapidly to ambient temperature to deactivate the lactase and sanitise the products. The skim milk products of Example 2 had the composition, expressed as g/100 g of mixture, as shown in Table 9.

TABLE 9
Composition of skim milk products of Example 2

| | Amount |
|---|---|
| Ingredient | (g/100 g) |
| MPC-85 | 4.08 |
| Mineral Mix | 0.54 |
| Maltodextrin | 5.38 |
| (various) | |
| Water | 90.00 |

Additional control samples were prepared as follows:
(1) a batch containing no added digestible polysaccharide hydrolysate to determine the impact of any residual carbohydrate contained in the MPC-85 on the protein during heating, 2(viii); and
(2) a batch containing maltodextrin (DE40-43) and lactose was prepared by blending the maltodextrin and lactose to approximate the case where MPC80 provided the milk protein content and digestible polysaccharide hydrolysate containing predominantly DP2 (maltose) was used to more closely replicate the carbohydrate content of regular milk, 2(ix).

In order to characterise the carbohydrate composition of the skim milk products, portions of all samples were analysed by HPLC as described in Example 1. The carbohydrate compositions of skim milk products of Example 2 are provided in Table 10.

TABLE 10
The principle component composition of different skim milk products of
Example 2. Carbohydrate component contents as determined by HPLC analysis
(Note: the values provided in Table 10 are g/100 mL of undiluted liquid
skim milk product unless indicated as grams on a dry solids basis).

| | Example | | | | | | | | |
|---|---|---|---|---|---|---|---|---|---|
| | | | | | | | | 2(viii) | 2(ix) |
| | 2(i) | 2(ii) | 2(iii) | 2(iv) | 2(v) | 2(vi) | 2(vii) | Control | Control |
| | MD | | | | | | | | |
| | | | | | | | | | DE40-43 |
| | DE | DE | DE | DE* | DE* | DE | DE | | lactose |
| | 8-10 | 10-12 | 17-20 | 28-31 | 28-31 | 37-41 | 40-43 | No MD** | blend*** |
| Milk Protein | 3.47 | 3.47 | 3.47 | 3.47 | 3.47 | 3.47 | 3.47 | 3.67 | 3.47 |
| DP4+ | 4.54 | 4.52 | 4.14 | 3.40 | 3.08 | 1.56 | 1.46 | 0.0 | 1.02 |
| DP3 | 0.39 | 0.43 | 0.57 | 0.75 | 0.59 | 1.36 | 1.14 | 0.0 | 1.04 |
| DP2 | 0.12 | 0.12 | 0.21 | 0.67 | 1.24 | 1.90 | 2.10 | 0.0 | 1.89 |
| DP1 (Total) | 0.21 | 0.17 | 0.33 | 0.43 | 0.35 | 0.43 | 0.55 | 0.28 | 1.29 |
| Glu (total) | 0.12 | 0.09 | 0.22 | 0.32 | 0.24 | 0.33 | 0.45 | 0.14 | 0.80 |
| Glu (from MD) | 0.03 | 0.02 | 0.10 | 0.21 | 0.13 | 0.23 | 0.35 | 0.00 | 0.30 |
| Glu (from | 0.09 | 0.08 | 0.12 | 0.11 | 0.11 | 0.10 | 0.10 | 0.14 | 0.50 |
| lactose) | | | | | | | | | |
| Gal (from | 0.09 | 0.08 | 0.12 | 0.11 | 0.11 | 0.10 | 0.10 | 0.14 | 0.50 |
| lactose) | | | | | | | | | |
| Total | 5.25 | 5.25 | 5.25 | 5.25 | 5.25 | 5.25 | 5.25 | 0.28 | 5.25 |
| carbohydrate | | | | | | | | | |
| DP4+ dsb (g) | 47.7 | 47.5 | 43.5 | 35.7 | 32.4 | 16.4 | 15.3 | 0 | 10.7 |
| DP3 dsb (g) | 4.1 | 4.5 | 5.9 | 7.9 | 6.2 | 14.3 | 12.0 | 0 | 10.9 |
| DP2 dsb (g) | 1.3 | 1.3 | 2.2 | 7.0 | 13.0 | 19.9 | 22.0 | 0 | 19.9 |
| DP1 dsb (g) | 2.2 | 1.8 | 3.5 | 4.5 | 3.7 | 4.5 | 5.8 | 6.0 | 13.6 |

Glu = glucose
Gal = galactose
dsb = dry solids basis
DE = Dextrose Equivalence of the maltodextrin tested
MD = maltodextrin
DP1 = Degree of polymerisation of the sugar is 1, specifically galactose and glucose
DP2 = Degree of polymerisation of the sugar is 2, specifically maltose
DP3 = Degree of polymerisation of the oligosaccharide is 3, specifically maltotriose
DP4+ Degree of polymerisation of the oligosaccharide is 4 or greater.
*Two different commercial DE 28-31 products which differed in proportions of DP1 (glucose) and DP2 (maltose) were used.
**In this control, maltodextrin was omitted and lactase was used to hydrolyse residual lactose in the MPC85 component of the composition.
***The added carbohydrate comprised 86% of DE 40-43 maltodextrin and 14% of lactose. In this control, MPC-80 provided the milk protein content and digestible polysaccharide hydrolysate containing predominantly DP2 (maltose) was used to more closely replicate the carbohydrate content of regular milk. The composition was treated with lactase to produce a lactose-free product.

As in Example 1, the data provided in Table 10 was utilised to investigate the extent to which different maltodextrins may affect such organoleptic, nutritional and appearance properties of skim milk products prepared with minerals supplied as food grade chemicals by calculation of the sugar to milk protein ratio and the RC to milk protein ratio as described herein. The results are provided in Table 11.

TABLE 11
Calculation of sugar to milk protein ratio and RC to milk
protein ratio using the HPLC data provided in Table 10.

| | Example | | | | | | | | |
|---|---|---|---|---|---|---|---|---|---|
| | | | | | | | | 2(viii) | 2(ix) |
| | 2(i) | 2(ii) | 2(iii) | 2(iv) | 2(v) | 2(vi) | 2(vii) | Control | Control |
| | MD | | | | | | | | |
| | | | | | | | | | DE40-43 |
| | DE | DE | DE | DE* | DE* | DE | DE | | lactose |
| | 8-10 | 10-12 | 17-20 | 28-31 | 28-31 | 37-41 | 40-43 | No MD** | blend*** |
| DP1 % of total | 3.9 | 3.2 | 6.3 | 8.2 | 6.7 | 8.2 | 10.5 | 100.0 | 24.7 |
| carbohydrate | | | | | | | | | |
| DP1 to milk | 0.06 | 0.05 | 0.10 | 0.12 | 0.10 | 0.12 | 0.16 | 0.08 | 0.37 |
| protein mass ratio | | | | | | | | | |
| RC (DP1) value | 21 | 17 | 33 | 43 | 35 | 43 | 55 | 28 | 129 |
| RC (DP1) to milk | 6.0 | 4.9 | 9.6 | 12.4 | 10.1 | 12.3 | 15.9 | 7.6 | 37.3 |
| protein mass ratio | | | | | | | | | |
| DP2 % of total | 2.3 | 2.3 | 4.0 | 12.7 | 23.5 | 36.1 | 39.9 | 0 | 36.1 |
| carbohydrate | | | | | | | | | |
| DP2 to milk | 0.03 | 0.03 | 0.06 | 0.19 | 0.36 | 0.55 | 0.60 | 0 | 0.55 |
| protein mass ratio | | | | | | | | | |
| RC (DP2) value | 7 | 7 | 12 | 39 | 72 | 110 | 122 | 0 | 110 |
| RC (DP2) to milk | 2.0 | 2.0 | 3.5 | 11.2 | 20.7 | 31.7 | 35.0 | 0 | 31.6 |
| protein mass ratio | | | | | | | | | |
| DP3 % of total | 7.4 | 8.2 | 10.8 | 14.3 | 11.2 | 26.0 | 21.7 | 0 | 19.8 |
| carbohydrate | | | | | | | | | |
| DP3 to milk | 0.11 | 0.12 | 0.16 | 0.22 | 0.17 | 0.39 | 0.33 | 0 | 0.30 |
| protein mass ratio | | | | | | | | | |
| RC (DP3) value | 15 | 17 | 22 | 30 | 23 | 54 | 45 | 0 | 41 |
| RC (DP3) to milk | 4.4 | 4.9 | 6.4 | 8.5 | 6.7 | 15.5 | 13.0 | 0 | 11.8 |
| protein mass ratio | | | | | | | | | |
| Sugar (DP1 + DP2) | 0.09 | 0.08 | 0.16 | 0.32 | 0.46 | 0.67 | 0.76 | 0.08 | 0.92 |
| to milk protein | | | | | | | | | |
| mass ratio | | | | | | | | | |
| Sugar RC | 8.0 | 7.0 | 13.1 | 23.5 | 30.8 | 44.0 | 51.0 | 7.6 | 68.9 |
| (DP1 + DP2) to milk | | | | | | | | | |
| protein mass ratio | | | | | | | | | |
| (DP1 + DP2 + DP3) | 0.21 | 0.21 | 0.32 | 0.53 | 0.63 | 1.06 | 1.09 | 0.08 | 1.22 |
| to milk protein | | | | | | | | | |
| mass ratio | | | | | | | | | |
| RC | 12.4 | 11.9 | 19.5 | 32.1 | 37.4 | 59.6 | 64.0 | 7.6 | 80.8 |
| (DP1 + DP2 + DP3) | | | | | | | | | |
| to milk protein | | | | | | | | | |
| mass ratio | | | | | | | | | |

*Two different commercial DE 28-31 products which differed in proportions of DP1 and DP2 were used.
**In this control, maltodextrin was omitted and lactase was used to hydrolyse residual lactose in the MPC85 component of the composition.
***The added carbohydrate comprised 86% of DE 40-43 maltodextrin and 14% of lactose. In this control, MPC-80 provided the milk protein content and digestible polysaccharide hydrolysate containing predominantly DP2 (maltose) was used to more closely replicate the carbohydrate content of regular milk. The composition was treated with lactase to produce a lactose-free product.

As in Example 1, estimations of sweetness, osmolality, nutritional value (reactive lysine) and colour development are provided in Table 12.

Expected sweetness values were calculated for each of the skim milk products made with different maltodextrin products using Relative Sweetness Factors as provided in Table 2. Results are provided in Table 12.

Osmolality was determined as in Example 1. Results are provided in Table 12.

Reactive lysine was determined as in Example 1. Results are provided in Table 12.

TABLE 12
The extent to which different maltodextrins may affect organoleptic, nutritional
and appearance properties of the skim milk products of Example 2.

| | Example | | | | | | | | |
|---|---|---|---|---|---|---|---|---|---|
| | | | | | | | | 2(viii) | 2(ix) |
| | 2(i) | 2(ii) | 2(iii) | 2(iv) | 2(v) | 2(vi) | 2(vii) | Control | Control |
| | MD | | | | | | | | |
| | | | | | | | | | DE40-43 |
| | | | | | | | | | lactose |
| | | | | | | | | No MD** | blend*** |
| | | | | | | | | Treated | Treated |
| | DE | DE | DE | DE* | DE* | DE | DE | with | with |
| | 8-10 | 10-12 | 17-20 | 28-31 | 28-31 | 37-41 | 40-43 | lactase | lactase |
| Sugar (DP1 + DP2) | 0.09 | 0.08 | 0.16 | 0.32 | 0.46 | 0.67 | 0.76 | 0.08 | 0.92 |
| to milk protein | | | | | | | | | |
| mass ratio | | | | | | | | | |
| Sugar RC | 8.0 | 7.0 | 13.1 | 23.5 | 30.8 | 44.0 | 51.0 | 7.6 | 68.9 |
| (DP1 + DP2) to milk | | | | | | | | | |
| protein mass ratio | | | | | | | | | |
| (DP1 + DP2 + DP3) | 0.21 | 0.21 | 0.32 | 0.53 | 0.63 | 1.06 | 1.09 | 0.08 | 1.22 |
| to milk protein | | | | | | | | | |
| mass ratio | | | | | | | | | |
| RC | 12.4 | 11.9 | 19.5 | 32.1 | 37.4 | 59.6 | 64.0 | 7.6 | 80.8 |
| (DP1 + DP2 + DP3) | | | | | | | | | |
| to milk protein | | | | | | | | | |
| mass ratio | | | | | | | | | |
| Calculated | 3.3 | 3.2 | 5.2 | 9.0 | 10.9 | 17.4 | 18.7 | 3.9 | 22.3 |
| sweetness | | | | | | | | | |
| Osmolality | 191 | 194 | 197 | 229 | 229 | 270 | 273 | 157 | 308 |
| mOsmoles/kg | | | | | | | | | |
| Reactive lysine | 99 | 98 | 103 | 95 | 98 | 99 | 93 | 100 | 91 |
| after heat | | | | | | | | | |
| treatment (% of | | | | | | | | | |
| control) **** | | | | | | | | | |
| Visual colour | no | no | no | no | no | no | slight | no | much |
| assessment after | colour | colour | colour | colour | colour | colour | brown | colour | more |
| heating | | | | | | | colour | | brown |
| | | | | | | | | | colour |

*Two different commercial DE 28-31 products which differed in proportions of DP1 and DP2 were used.
**In this control, maltodextrin was omitted and lactase was used to hydrolyse residual lactose in the MPC85 component of the composition.
***The added carbohydrate comprised 86% of DE 40-43 maltodextrin and 14% of lactose. In this control, MPC-80 provided the milk protein content and digestible polysaccharide hydrolysate containing predominantly DP2 (maltose) was used to more closely replicate the carbohydrate content of regular milk. The composition was treated with lactase to produce a lactose-free product.
**** The reactive lysine result was standardised to the control milk product 2(viii)), hence the reactive lysine entry in Table 12 for 2(viii) is 100.

From the results of in Table 12, the composition of maltodextrins that are suitable for the replacement of lactose in order to prepare lactose-free skim milk products that have milk-like nutritional, organoleptic and functional properties was found to be in the DE range of 8-43, more specifically the DE range of 8-31, when food grade non-dairy derived minerals are included. However, providing minerals in the composition as food grade chemicals enabled the use of maltodextrins with a higher content of DP1 sugars, because there was no additional lactose (that could be hydrolysed to glucose and galactose) in the mineral source. As there was no additional glucose and galactose arising from the mineral source as it lacked protein ratio and lower values of RC to protein ratio when compared to the skim milk products of Example 1 could be prepared.

It therefore appears that for skim milk products that include non-dairy derived minerals, the (DP1+DP2+DP3) to milk protein ratio on a mass basis should be any number in the range of 0.21 to 1.09 and more specifically any number in the range of 0.21 to 1.06 and even more specifically any number in the range of 0.32-0.63 as can be seen in Example 2. Further, the RC(DP1+DP2+DP3) to milk protein mass ratio of the milk products of Example 2 can be any number in the range of 11.9 to 64.0 and more specifically in the range of 11.9 to 59.6, and even more specifically in the range of 19.5-59.6, and even more specifically in the range of 19.5 to 37.4.

### EXAMPLE 3. Preparation of Dry Lactose-Free Skim Milk Product with the Same Nutritional Composition as Skim Milk Powder (SMP) including Minerals Supplied as Food Grade Chemicals

The target nutritional composition was that of a commercial skim milk powder as provided in Table 13.

TABLE 13
The composition of principal components
of a commercial skim milk powder

| Skim Milk Powder | |
|---|---|
| (Devondale brand) | |
| Principal components | % of product |
| Protein | 35.2 |
| Fat | 1.2 |
| Carbohydrate | 53.2 |
| (Carbohydrate as Lactose) | 53.2 |
| Ash/minerals (by subtraction) | 7.4 |
| Total Solids | 97.0 |
| Moisture | 3.0 |
| Energy (kJ/100 g) | 1512 |
| Calculated sweetness | 8.5 |

The nutritional composition corresponding to that described in Table 13 was prepared using the following process steps:
Milk protein concentrate (MPC) was obtained to provide the required protein and to partially provide the required levels of carbohydrate and mineral.
Dairy-appropriate minerals were added to achieve the desired mineral content.
The mix was treated with lactase to hydrolyse the carbohydrate provided by the milk protein concentrate.
The contents of galactose and glucose in the mix were determined as a measure of the contribution of dairy components to the sweetness and DE.
Maltodextrin was added directly to the mix to obtain the full carbohydrate requirement, taking into account the carbohydrate addition provided by the MPC
Maltodextrin having DE=17-20 and a low maltose content was selected according to experimental results provided in Example 2. The mixture was pasteurised to inactivate the lactase and control bacterial contamination.
The mixture was spray dried to a powder.

Skim milk was concentrated by ultrafiltration at 10° C. using polymeric membranes with nominal 10,000 Dalton molecular weight cut off (MWCO) in a commercial dairy manufacturing plant. To the retained concentrate still under recirculation and filtration demineralised water at 10° C. was added and concentration continued until the total solids content was about 18% w/w and the protein content of the resulting Milk Protein Concentrate (MPC) was at least 85% on a dry solids basis. A portion of this liquid material was taken for the preparation of dry lactose-free skim milk product. In the commercial manufacturing plant the liquid MPC product was vacuum evaporated and spray dried to yield an MPC powder product. Analysis of this powder product provided the composition of the MPC shown in Table 14.

TABLE 14
Analysis of principal components of commercially-
dried MPC as used in liquid concentrate form for
the preparation of dry lactose-free skim milk product

| Principal | % w/w as is | % w/w dry solids basis |
|---|---|---|
| components of MPC | commercially dried MPC | commercially dried MPC |
| Lactose | 4.4 | 4.6 |
| Carbohydrate | 4.4 | 4.6 |
| Fat | 1.4 | 1.5 |
| Protein | 81.5 | 86.1 |
| Ash/minerals | 7.5 | 7.9 |
| Moisture | 5.3 | 0 |
| Calculated | 0.7 | 0.7 |
| sweetness | | |

On the basis of known concentrations (Canadian Dairy Commission. (see http://milkingredients.ca/index-eng.php) of the principal mineral anions and cations in SMP, a mixture of inorganic chemicals was prepared as in Example 2, Table 8.

To 4000 g of MPC at 18% w/w solids content at 10° C. and pH within the range 6.4-6.7, lactase enzyme was added in accordance with the manufacturer's recommendation based on the calculated residual lactose content and continuously stirred for 24 hours at 10° C. by which time the lactose content was determined by HPLC analysis to be not-detectable.

To the lactose hydrolysed MPC was added 95.8 g of the prepared mineral mix and 950 g of the selected maltodextrin with vigorous stirring.

The mixture was batch pasteurised at 67° C., cooled to 55° C. and with continuous stirring was spray dried using a DryTek Pilot spray drier to complete the preparation of a dry lactose-free skim milk product.

To confirm that the composition of the dry product was consistent with calculated values for principal components and that the product was lactose-free, a sample was submitted to an accredited food analytical laboratory for independent assessment (National Measurement Institute, Australian Government Department of Industry, Innovation and Science). The composition of the prepared dry lactose-free skim milk product is provided in Table 15.

TABLE 15
The composition of principal components of dry
lactose-free skim milk product and comparison
with the composition of skim milk powder (SMP)

| | Dry lactose-free skim | SMP Target |
|---|---|---|
| Principal component | milk product % w/w | range % w/w |
| Lactose | <0.2 | 49.5-54.0 |
| Carbohydrate (total) | 54.0 | 49.5-54.0 |
| (Glucose + Galactose) | 2.0 | 0 |
| (Maltose) | 2.1 | 0 |
| Fat | 0.6 | 0.6-1.25 |
| Protein | 34.8 | 34.0-37.0 |
| Ash/minerals | 7.7 | 8.2-8.6 |
| Moisture | 3.3 | 3.0-4.0 |
| Energy (kJ/100 g) | 1510 | 1512 |
| Calculated sweetness | 10.9 | 7.9-8.6 |

As can be seen from Table 15, dry lactose-free skim milk product was prepared with composition confirmed within the SMP target range for all principal non-carbohydrate components. Colour and flavour of the dry lactose-free skim milk product were comparable to that of regular skim milk. Using maltodextrin DE17-20 to replace the lactose resulted in sweetness comparable to regular non-fat milk. The sugar (DP1+DP2) portion of the total carbohydrate was measured to be 7.6% and the sugar (DP1+DP2) to milk protein ratio was 0.12. This is much lower than could be achieved if milk minerals were used to supply the required minerals to the product (see Table 7 of Example 1 as a comparison). The sugar RC (DP1+DP2) to protein mass ratio was calculated to be 9.2. The lactose-free skim milk product prepared as a spray dried powder was stable, non-caking and comparable in colour to SMP.

### EXAMPLE 4. Preparation of Dry Lactose-Free Fat-Containing Milk Product with the Same Nutritional Composition as Whole Milk Powder (WMP) including Non-Dairy Derived Food Grade Minerals and Dairy Cream

The target nutritional composition was that of a commercial whole milk powder as provided in Table 16.

TABLE 16
The composition of principal components
of a commercial whole milk powder

| | | | % of non-fat |
|---|---|---|---|
| Whole Milk Powder | % of | % of product | components, |
| (Devondale brand) | product as | dry solids | dry solids |
| Principal components | is basis | basis | basis |
| Protein | 26.0 | 26.8 | 38.1 |
| Fat | 27.8 | 28.7 | — |
| Carbohydrate | 37.6 | 38.8 | 53.8 |
| (Carbohydrate as Lactose) | 37.6 | 38.8 | 53.8 |
| Ash/minerals (by subtraction) | 5.6 | 5.8 | 8.0 |
| Total Solids | 97.0 | 100 | 100 |
| Moisture | 3.0 | 0 | 0 |
| Energy (kJ/100 g) | 2166 | 2233 | — |
| Calculated sweetness | 6.0 | 6.2 | 8.6 |

The nutritional composition corresponding to that described in Table 16 was prepared using the following process steps:
Milk protein concentrate (MPC85) was obtained to provide the majority of the required protein and to partially provide the required levels of carbohydrate, mineral and fat.
Dairy appropriate minerals were added to achieve the desired mineral content.
Dairy cream was added to provide the desired fat content of the final product also contributing to the protein, mineral and lactose content
The mix was treated with lactase to hydrolyse the carbohydrate provided by the milk protein concentrate and cream.
The contents of galactose and glucose in the mix were determined as a measure of the contribution of dairy components to the sweetness and DE.
Maltodextrin was added directly to the mix to obtain the full carbohydrate requirement, taking into account the carbohydrate addition provided by the MPC and dairy cream.
Maltodextrin having DE=17-20 and a low maltose content was selected according to experimental results provided in Example 2.
The mixture was pasteurised to inactivate the lactase and control bacterial contamination.
The mixture was spray dried to a powder.

MPC was prepared and provided as in Example 3.

An appropriate mixture of inorganic chemicals was provided as in Example 3

Dairy cream was provided with the composition shown in Table 17.

TABLE 17
Composition of commercial dairy cream used in the preparation
of lactose-free fat-containing dairy milk product

| Principal component | % w/w of dairy cream |
|---|---|
| Lactose | 3.1 |
| Carbohydrate | 3.1 |
| Fat | 44.0 |
| Protein | 2.1 |
| Ash/minerals | 0.5 |
| Moisture | 47.2 |

To 4000 g of MPC at 18% w/w solids content at 10° C. and pH within the range 6.4-6.7, was added 1425 g of cream (44% fat content, 10° C.). Lactase enzyme was added in accordance with the manufacturer's recommendation based on the calculated residual lactose content and continuously stirred for 24 hours at 10° C. by which time the lactose content was determined by HPLC analysis to be not-detectable.

To the lactose hydrolysed MPC and cream was added 95.8 g of the prepared mineral mix and 950 g of the selected maltodextrin with vigorous stirring.

The mixture was batch pasteurised at 67° C., cooled to 55° C., homogenised with a 2-stage dairy homogeniser and continuously spray dried using a DryTek Pilot spray drier to complete the preparation of a dry lactose-free fat-containing milk product (lactose-free FDP).

To confirm that the composition of the dry product was consistent with calculated values for principal components and that the product was lactose-free, a sample was submitted to an accredited food analytical laboratory for independent assessment as in Example 3. The composition of the prepared lactose-free FDP is provided in Table 18.

TABLE 18
The composition of principal components of lactose-
free fat-containing dairy milk powder (FDP) and comparison
with the composition of whole milk powder (WMP)

| | Lactose-free | WMP % w/w |
|---|---|---|
| Principal component | FDP % w/w | Target range |
| Lactose | <0.2 | 36.0-38.5 |
| Carbohydrate (total) | 40.0 | 36.0-38.5 |
| (Glucose + galactose) | 2.7 | 0 |
| (Maltose) | 1.5 | 0 |
| Fat | 25.8 | 26.0-28.5 |
| Protein | 26.2 | 24.5-27.0 |
| Ash/minerals | 5.9 | 5.5-6.5 |
| Moisture | 2.0 | 2.0-4.5 |
| Energy (kJ/100 g) | 2080 | 2166 |
| Calculated sweetness | 7.8 | 5.8-6.2 |

As can be see from Table 18, lactose-free FDP was prepared with confirmed composition within the WMP target range for all principal non-carbohydrate components. Colour and flavour were comparable to that of natural whole milk. Using maltodextrin DE17-20 combined with additional monosaccharides from the hydrolysed cream resulted in sweetness comparable to regular whole milk. The sugar (DP1+DP2) portion of the total carbohydrate was measured to be 10.5% and the sugar (DP1+DP2) to milk protein mass ratio was 0.16. This is much lower than could be achieved if milk minerals were used to supply the required minerals to the composition (see Table 7 of Example 1 as a comparison). The sugar RC(DP1+DP2) to milk protein mass ratio was 13.6. Lactose-free FDP was stable, non-caking and comparable in colour and flavour to WMP.

### EXAMPLE 5. Preparation of Lactose-Free Fat Containing Dairy Milk Product with the Same Nutritional Composition as Whole Milk Powder (WMP) including Non-Dairy Derived Food Grade Minerals and Anhydrous Milk Fat as the Fat Source

As in Example 4, the target nutritional composition in this example was that of a commercial whole milk powder as provided in Table 18 but instead of including dairy cream as the fat source as in Example 4, anhydrous milk fat (AMF) was incorporated into the composition. The AMF contributed to the colour and flavour of the composition but did not impact on the sweetness or DE of the composition. Maltodextrin DE28-31 was used to provide additional sweetness and compensate for the lactose content of the cream used in Example 4.

The nutritional composition corresponding to that described in Table 18 was prepared using the following process steps:
Milk protein concentrate (MPC) was obtained to provide the required protein and to partially provide the required levels of carbohydrate, mineral and fat.
Dairy appropriate minerals were added to achieve the desired mineral content.
The mix was treated with lactase to hydrolyse the carbohydrate provided by the milk protein concentrate.
The contents of galactose and glucose in the mix were determined as a measure of the contribution of dairy components to the sweetness and DE.
Maltodextrin was added directly to the mix to obtain the full carbohydrate requirement, taking into account the carbohydrate addition provided by the MPC.
Maltodextrin DE28-31 and a low maltose content was selected according to experimental results provided in Example 2.
The mix was heated to 50° C. and anhydrous milk fat was added in liquid state at 50° C. to provide the desired fat content of the final product.
The mixture was pasteurised and homogenised to inactivate the lactase, control bacterial contamination and disperse the milk fat uniformly as an emulsion stabilised by milk protein.
The mixture was spray dried to a powder.

MPC was prepared and provided as in Example 3.

An appropriate mixture of inorganic chemicals was provided as in Example 3

Dairy fat was provided as AMF in liquid state.

To 4000 g of MPC at 18% w/w solids content at 10° C. and pH within the range 6.4-6.7, was added lactase enzyme in accordance with the manufacturer's recommendation based on the calculated residual lactose content and continuously stirred for 24 hours at 10° C. by which time the lactose content was determined by HPLC analysis to be not-detectable.

To the lactose hydrolysed MPC was added 95.8 g of the prepared mineral mix and 950 g of the selected maltodextrin with vigorous stirring.

The mixture was heated to 50° C. and to it was added with vigorous stirring 685 g AMF in liquid state at 50° C.

The mixture while being continuously stirred vigorously was pasteurised at 67° C., cooled to 55° C., homogenised with a 2-stage dairy homogeniser and continuously spray dried using a DryTek Pilot spray drier to complete the preparation of lactose-free FDP.

To confirm that the composition of the dry product was consistent with calculated values for principal components and that the product was lactose-free, a sample was submitted to an accredited food analytical laboratory for independent assessment as in Example 3. The composition of the prepared lactose-free FDP is provided in Table 19.

TABLE 19
The composition of principal components of lactose-
free FDP formulated using AMF as the fat source
and comparison with the composition of WMP

| | Lactose-free | WMP % w/w |
|---|---|---|
| Principal component | FDP % w/w | Target range |
| Lactose | <0.2 | 36.0-38.5 |
| Carbohydrate | 38.0 | 36.0-38.5 |
| Fat | 28.0 | 26.0-28.5 |
| Protein | 26.2 | 24.5-27.0 |
| Ash/minerals | 5.9 | 5.5-6.5 |
| Moisture | 2.0 | 2.0-4.5 |
| Energy (kJ/100 g) | 2100 | 2166 |
| Calculated sweetness | 7.6 | 5.8-6.2 |

### EXAMPLE 6. Larger Scale Preparation of Lactose-Free Skim Milk Powder with the Same Nutritional Composition as Skim Milk Powder (SMP) including Dairy-Derived Mineral Ingredients and Maltodextrin DE28-31

The target nutritional composition was that of a commercial skim milk powder as provided in Table 13.

The nutritional composition corresponding to that described in Table 13 was prepared using the process steps as in Example 3 except that a combination of dairy-derived mineral ingredients was included in the composition instead of a blend of non-dairy derived minerals supplied as food grade minerals. The composition of the dairy-derived mineral ingredients is provided in Table 20.

TABLE 20
Composition of dairy-derived mineral ingredients (g/100 g product)

| Dairy Ingredient | Ash | Ca | K | Na | N × 6.38 | Lactose | Total solids |
|---|---|---|---|---|---|---|---|
| Mineral Powder | 33.5 | 8.5 | n/a | n/a | 15 | 44 | 95.5 |
| Mineral Concentrate | 24 | 0.15 | 9 | 2.7 | 6.5 | 6.3 | 37 |

To 20,000 g of MPC at 18% w/w solids content at 10° C. and pH within the range of 6.4-6.7, was added 555 g Mineral Powder, 775 g Mineral Concentrate and 4,985 g Maltodextrin having a DE of 28-31 with vigorous stirring. Lactase enzyme was added in accordance with the manufacturer's recommendation based on the calculated residual lactose content and continuously stirred for 24 hours at 10° C. by which time the lactose content was determined by HPLC analysis to be not-detectable.

The mixture was batch pasteurised at 67° C., cooled to 55° C. and with continuous stirring was spray dried using a Niro Minor Spray drier to complete the preparation of lactose-free skim milk powder (lactose-free SMP).

To confirm that the composition of the lactose-free SMP was consistent with calculated values for principal components and that the product was lactose-free, a sample was submitted to an accredited food analytical laboratory for independent assessment (National Measurement Institute, Australian Government Department of Industry, Innovation and Science). The composition of the prepared lactose-free skim milk powder is provided in Table 21.

TABLE 21
The composition of principal components of lactose-free
SMP and comparison with the composition of SMP (g/100 g)

| | Lactose-free | SMP % w/w |
|---|---|---|
| Principal component | SMP % w/w | Target range |
| Lactose | <0.2 | 49.5-54.0 |
| Carbohydrate (total) | 53.0 | 49.5-54.0 |
| (Glucose + Galactose) | 5.8 | 0 |
| (Maltose) | 4.6 | 0 |
| (Maltotriose) | 5.1 | 0 |
| Fat | 0.9 | 0.6-1.25 |
| Protein | 34.4 | 34.0-37.0 |
| Ash/minerals | 6.5 | 8.2-8.6 |
| Moisture | 5.1 | 3.0-4.0 |
| Energy (kJ/100 g) | 1520 | 1512 |
| Calculated sweetness | 13.7 | 7.9-8.6 |

A 100 g sample of the resulting lactose-free SMP was reconstituted with water to achieve the target concentration of 100 g/kg total solids. Organoleptic assessment by a panel confirmed that the composition had sweetness, mouthfeel and dairy milk flavour comparable to SMP.

The sugar (DP1+DP2) portion of the total carbohydrate was measured to be 19.6% and the sugar (DP1+DP2) to protein ratio was 0.30. The sugar RC(DP1+DP2) to milk protein mass ratio was calculated to be 24.6. Likewise, the (DP1+DP2+DP3) portion of the total carbohydrate was 29.2%. The (DP1+DP2+DP3) to milk protein mass ratio was 0.45. The RC (DP1+DP2+DP3) to milk protein ratio was 29.0.

### EXAMPLE 7. Larger Scale Preparation of Lactose-Free Fat Containing Dairy Milk Products with the Same Nutritional Composition as Whole Milk Powder (WMP) including Dairy-Derived Mineral Ingredients and Dairy Cream

The target nutritional composition was that of a commercial whole milk powder as provided in Table 16.

The nutritional composition corresponding to that described in Table 16 was prepared using the process steps as in Example 4 except that a combination of dairy-derived mineral ingredients was included in the composition instead of a blend of non-dairy derived minerals supplied as food grade minerals. The compositions of the dairy-derived mineral ingredients are provided in Table 20.

To 20,000 g of MPC at 18% w/w solids content at 10° C. and pH within the range of 6.4-6.7, was added 9937 g of cream (40% fat content, 10° C.), 439 g Mineral Powder, 612 g Mineral Concentrate and 4,978 g of Maltodextrin 28-31DE with vigorous stirring. Lactase enzyme was added in accordance with the manufacturer's recommendation based on the calculated residual lactose content and continuously stirred for 24 hours at 10° C. by which time the lactose content was determined by HPLC analysis to be not-detectable.

The mixture was batch pasteurised at 67° C., cooled to 55° C., homogenised with a 2-stage dairy homogeniser and continuously spray dried using a Niro Minor Spray drier to complete the preparation of lactose-free FDP.

The resulting powder was agglomerated and instantised to provide improved powder dispersion when added to water. This was achieved by the application of lecithin (a surfactant) to the powder particles in a 2nd stage batch drying system using standard conditions.

A 150 g sample of the resulting lactose-free FDP was reconstituted with water to achieve the target concentration of 150 g/kg total solids. Organoleptic assessment by a panel confirmed that the composition had sweetness, mouthfeel and dairy milk flavour comparable to WMP.

To confirm that the composition of the lactose-free FDP was consistent with calculated values for principal components and that the product was lactose-free, a sample was submitted to an accredited food analytical laboratory for independent assessment as in Example 3. The composition of the prepared lactose-free FDP is provided in Table 22.

TABLE 22
The composition of principal components of lactose-
free FDP and comparison with the composition of WMP

| | Lactose-free | WMP % w/w |
|---|---|---|
| Principal component | FDP % w/w | Target range |
| Lactose | <0.2 | 36.0-38.5 |
| Carbohydrate (total) | 39.0 | 36.0-38.5 |
| (Glucose + Galactose) | 5.2 | 0 |
| (Maltose) | 3.2 | 0 |
| (Maltotriose) | 3.4 | 0 |
| Fat | 29.1 | 26.0-28.5 |
| Protein | 24.9 | 24.5-27.0 |
| Ash/minerals | 5.1 | 5.5-6.5 |
| Moisture | 3.4 | 2.0-4.5 |
| Energy (kJ/100 g) | 2160 | 2166 |
| Calculated sweetness | 7.5 | 5.8-6.2 |

The sugar (DP1+DP2) portion of the total carbohydrate was measured to be 21.5% and the sugar (DP1+DP2) to milk protein ratio was 0.34. The sugar RC(DP1+DP2) to milk protein mass ratio was calculated to be 28.3. Likewise, the (DP1+DP2+DP3) portion of the total carbohydrate was 30.3%. The (DP1+DP2+DP3) to milk protein mass ratio was 0.47. The RC(DP1+DP2+DP3) to protein ratio was 33.7.

### EXAMPLE 8. Preparation of Lactose-Free Fermented Liquid Milk Product Using Lactose-Free Dairy Milk Powders

25 g each of lactose-free milk powder products of Examples 6 (LF-SMP) and 7 (LF-FDP) were separately reconstituted in 200 ml aliquots of water and heated to 45° C. 5 g of commercial active natural yoghurt were blended into 50 ml aliquots of each suspension and added back as inoculum to the relevant milk preparation. The cultures were incubated at 40° C. for 4 hours and allowed to cool to about 30° C. overnight.

Both milk preparations resulted in a well set yoghurt-like appearance which provided a creamy product on stirring, with a pleasant mild milk-like acidic flavour. pH had fallen to around 4.6.

### EXAMPLE 9. Preparation of Lactose-Free Concentrated-Milk Products from Lactose-Free Skim Milk Powder and Lactose-Free Fat Containing Milk Product

Regular non-fat, reduced-fat or full-cream evaporated (concentrated) milk is prepared by evaporating skim milk, reduced-fat milk or whole milk to a total solids level of about 25% then heat sterilising the product by retorting in cans, pouches or other sterilisable packs.

Lactose-free equivalent product is preferably prepared from either skim or fat-containing lactose-free milk concentrate as prepared in Example 6 or Example 7. A reduced-fat product of the same type would be prepared similarly by addition of an intermediate level of fat. As the solids content of such lactose-free milk-like concentrates is typically in the range 35-38%, evaporation is not required. Instead the lactose-free milk concentrate is diluted with potable water or other suitable diluent to achieve a solids content of about 25% comparable to regular evaporated milk products prior to heat sterilisation.

Alternatively, the desired lactose-free evaporated-milk products are prepared directly by reconstituting lactose-free milk powder products as prepared in Examples 6 and 7 to the required solids level and then heat sterilising.

Alternatively, lactose-free concentrated milk products are prepared by reconstituting lactose-free skim milk powder and recombining with a desired quantity of fat or oil from a dairy or non-dairy source such as a suitable vegetable or animal source to produce lactose-free recombined concentrated milk products.

Alternatively, lactose-free concentrated milk products are prepared from lactose-free milk concentrate or powder as aforesaid at a solids level comparable to skim milk (about 10.5%) for a non-fat product or at a solids level comparable to whole milk (about 14.5%) for a fat-containing product and then extensively heated to denature the whey proteins, typically at 85° C. for 30 minutes before evaporating to about 25% solids and sterilising.

### Preparation of Lactose-Free Non-Fat Evaporated-Milk Product

To 369 g of potable water at 50° C. was added 131 g of lactose-free SMP prepared as in Example 6 with vigorous stirring to achieve complete dispersion of the solids and a concentrated milk product at 25% solids content equivalent to non-fat evaporated milk.

For comparison, using the same procedure, a product was also made using regular SMP instead of lactose-free SMP (LF-SMP).

To simulate and evaluate the outcome of the preservation method of in-can sterilisation normally applied to evaporated milk, 100 mL aliquots of both non-fat preparations were placed into thick-walled glass bottles and sterilised using a pressure cooker at 15 psi.

The sterilised lactose-free skim milk concentrate had acceptable colour and flavour that was comparable to the skim milk concentrate prepared with commercial skim milk powder.

It is noted that the (DP1+DP2+DP3) to milk protein mass ratio and the RC (DP1+DP2+DP3) to milk protein mass ratio is the same as for the product in Example 6.

### Preparation of Lactose-Free Fat-Containing Evaporated-Milk Product

To 369 g of potable water at 50° C. was added 131 g of lactose-free FDP prepared as in Example 7 with vigorous stirring to achieve complete dispersion of the solids and a concentrated fat-containing milk product at 25% solids content equivalent to evaporated milk made from whole milk

For comparison, using the same procedure, product was also made using regular WMP instead of lactose-free FDP (LF-FDP).

To simulate and evaluate the outcome of the preservation method of in-can sterilisation normally applied to evaporated milk, 100 mL aliquots of both fat-containing preparations were placed into thick-walled glass bottles and sterilised using a pressure cooker at 15 psi.

The sterilised lactose-free fat containing dairy milk concentrate had acceptable colour and flavour that was comparable to the fat-containing milk concentrate prepared with commercial fat containing dairy milk powder.

It is noted that the (DP1+DP2+DP3) to milk protein mass ratio and the RC(DP1+DP2+DP3) to milk protein mass ratio is the same as for the product in Example 7.

### EXAMPLE 10. Preparation of Lactose-Free Sweetened Concentrated-Milk Products from Lactose-Free Skim Milk Powder and Lactose-Free Fat Containing Milk Product

Regular non-fat, reduced-fat or full-cream sweetened concentrated (condensed) milk is prepared by evaporating skim milk, reduced-fat milk or whole milk to a total solids level of about 28%. Sugar (sucrose) is added so that the total sugar concentration in the water phase is between 62.5% and 64.5% for microbiological preservation.

Lactose-free sweetened concentrated milk product is preferably prepared from either lactose-free skim milk concentrate or lactose-free fat-containing milk concentrate as prepared in Example 6 or Example 7. A reduced-fat product of the same type would be prepared similarly by addition of an intermediate level of fat. As the solids content of such lactose-free milk concentrates is typically in the range 35-38%, the lactose-free milk concentrate is diluted with potable water or other suitable diluent to achieve a solids content of about 28% as in the preparation of regular sweetened condensed milk products prior to addition of sugar.

Alternatively, the desired lactose-free sweetened concentrated milk products are prepared directly by reconstituting lactose-free powder products as prepared in Examples 6 and 7 to the desired solids content prior to addition of sugar.

### Preparation of Lactose-Free Sweetened Condensed Skim Milk Product

To 145 g of potable water at 50° C. was added 131 g of lactose-free SMP prepared as in Example 6 with vigorous stirring to achieve complete dispersion of the solids and a concentrated milk product at 28% solids content. With vigorous stirring 191 g of sucrose was added and the mixture heated to 50° C. to facilitate complete dissolution of the sugar. The composition was pasteurised at 73° C. for 15 minutes, cooled and stored.

For comparison, using the same procedure, product was also made using regular SMP instead of LF-SMP.

To evaluate the outcome of the preservation method over time, 100 mL aliquots of both preparations were placed into sterile glass bottles. Samples were stored at ambient temperature and at 37° C. and assessed after intervals of time from 1 hour to 7 days.

After 7 days storage at ambient and 37° C., the concentrated lactose-free sweetened condensed skim milk product had an acceptable colour and flavour that was comparable to the sweetened condensed skim milk product made with commercial skim milk powder. Interestingly, a sediment rapidly formed in the experimental product made with skim milk powder but not with the powder product of Example 6.

### Preparation of Lactose-Free Fat-Containing Sweetened Condensed-Milk Product

To 145 g of potable water at 50° C. was added 131 g of lactose-free FDP prepared as in Example 7 with vigorous stirring to achieve complete dispersion of the solids and a concentrated milk product at 28% solids content. With vigorous stirring 191 g of sucrose was added and the mixture heated to 50° C. to facilitate complete dissolution of the sugar. The composition was pasteurised, cooled and stored. For comparison, using the same procedure, product was also made using regular WMP instead of LF-FDP.

To evaluate the outcome of the preservation method over time, 100 mL aliquots of both preparations were placed into sterile glass bottles. Samples were stored at ambient temperature and at 37° C. and assessed after intervals of time from 1 hour to 7 days

After 7 days storage at ambient and 37° C., the concentrated lactose-free fat-containing sweetened condensed-milk product had an acceptable colour and flavour that was comparable to the fat-containing sweetened condensed milk product made with commercial fat-containing dairy milk powder. Interestingly, a sediment rapidly formed in the experimental product made with skim milk powder but not with the powder product of Example 7.

### EXAMPLE 11. Preparation of Lactose-Free Dairy Ice Cream Product from Lactose-Free Fat-Containing Milk Product

Dairy ice cream can be prepared from many different dairy and non-dairy ingredients to achieve products of widely different quality and cost. For evaluation of lactose-free dairy food compositions of this invention in a dairy ice cream, simple general ice cream compositions were prepared enabling quality to be compared to a similar ice cream composition made from regular full-lactose milk product and regular dairy cream as in Table 23.

TABLE 23
Ice cream compositions

| | Regular | Lactose-free |
|---|---|---|
| Ingredient | ice cream (g) | ice cream (g) |
| WMP | 146 | — |
| LF-FDP | — | 146 |
| 22% fat cream | 377 | — |
| Lactose-free 22% fat cream | — | 377 |
| Sucrose | 150 | 150 |
| Water | 327 | 327 |
| Total | 1000 | 1000 |

A quantity of 22% fat cream was rendered lactose-free by addition of lactase enzyme as in Example 4.

The required quantity of water for each composition was heated to 50° C. in a stirred jacketed vessel to which was added the WMP or LF-FDP with vigorous mixing until uniformly dispersed and then the sugar and stirred until completely dissolved. The regular cream or the lactose-free cream as appropriate was added and mixed thoroughly. Each mix was placed in an ice-cream maker and continuously stirred until uniformly frozen.

Ice cream products made with LF-FDP from Example 7 and regular WMP were assessed to be comparable in flavour, colour and texture.

### EXAMPLE 12. Preparation of Lactose-Free Milk Chocolate Product Using Lactose-Free Fat Containing Milk Product as the Dairy Ingredient of the Composition and Compared to the use of Regular Whole Milk Powder (WMP)

Milk chocolate is made traditionally by mixing milk powder together with cocoa solids and sugar followed by refining, conching and tempering.

An alternative method involves adding cocoa solids to milk and sugar, applying heat to achieve some caramelisation and then drying to produce chocolate crumb. Milk chocolate is then prepared by adding more cocoa solids to the chocolate crumb together with additional cocoa butter and butter oil followed by refining conching and tempering.

LF-SMP from Example 6 or LF-FDP from Example 7 was used to prepare milk chocolate by both processes to demonstrate the ability to prepare lactose-free milk chocolate.

### Preparation of Lactose-Free Milk Chocolate including LF-FDP by Direct Mixing of Dry Ingredients

Dark chocolate (29.6 g) containing 90% cocoa solids including 53.4% cocoa butter was melted in a steam heated double-cooker. To this was slowly added with continuous mixing ultra-fine sugar (60.3 g) dry bended with LF-FDP (23.6 g) and butter oil (6 g) then heated at 90° C. for 15 min then cooled

For comparison, using the same procedure, product was also made using regular WMP instead of LF-FDP.

Milk chocolate products made with LF-FDP and regular WMP were assessed to be comparable in flavour and other organoleptic properties.

### Preparation of Lactose-Free Milk Chocolate Crumb including LF-SMP

Water (57 g) was steam heated to 50° C. in a double cooker. To this was added LF-SMP (41 g) with stirring and when uniformly dispersed, fine sugar (76 g) was added. When the sugar was fully dissolved chocolate containing 90% cocoa solids (12 g) was added and thoroughly mixed. The mixture was heated to 90° C. and held at 90° C. for 15 minutes. After cooling to 70° C. the mix was poured onto silicone-coated drying trays and the resulting chocolate crumb dried to constant weight.

For comparison, using the same procedure, chocolate crumb product was also made using regular SMP instead of LF-SMP.

Chocolate crumb products made with LF-SMP and regular SMP were assessed to be comparable in flavour and other organoleptic properties.

1. A skim milk product or fat containing milk product comprising a concentrated milk protein component and a carbohydrate component wherein the carbohydrate component comprises:
(i) an amount of a DP1 sugar selected from the group consisting of glucose, galactose, fructose or a combination thereof that is in total 3.0-18.0% w/w of the total carbohydrate component, and
(ii) an amount of a DP2 sugar selected from the group consisting of maltose, lactose, sucrose, di-fructose or a combination thereof that is in total 2.0-40.0% w/w of the total carbohydrate component, and
(iii) one or more digestible polysaccharide hydrolysates selected from the group consisting of dextrins, maltodextrins, malto-triose, glucose syrups, polyfructose, fructose syrups or a combination thereof wherein the one or more digestible polysaccharide hydrolysates provide in total an amount of a DP3 oligosaccharide that is 6.0-26.0% w/w of the total carbohydrate component, and
(iv) less than 0.2% w/w of lactose on a dry solids basis;
and wherein the milk protein component is between 23.0%-38.0% w/w of the product on a dry solids basis and the milk product has a reductive carbohydrate (DP1+DP2+DP3) to milk protein mass ratio of 10.0-70.0.

2. The product according to claim 1, wherein the reductive carbohydrate (DP1+DP2+DP3) to milk protein mass ratio is 12.0-64.0.

3. The product according to claim 1, wherein the reductive carbohydrate (DP1+DP2+DP3) to milk protein mass ratio is 19.0-50.0.

4. The product according to claim 1, wherein the reductive carbohydrate (DP1+DP2+DP3) to milk protein mass ratio is 32.0-60.0.

5. The product according to claim 1, wherein the reductive carbohydrate (DP1+DP2+DP3) to milk protein mass ratio is 35.0-50.0.

6. The product according to any one or claims 1-5, wherein the one or more digestible polysaccharide hydrolysates have a Dextrose Equivalence of 8-43.

7. The product according to claim 6, wherein the one or more digestible polysaccharide hydrolysates have a Dextrose Equivalence of 8-41.

8. The product according to claim 6, wherein the one or more digestible polysaccharide hydrolysates have a Dextrose Equivalence of 8-31.

9. The product according to claim 6, wherein the one or more digestible polysaccharide hydrolysates have a Dextrose Equivalence of 15-31.

10. The product according to claim 6, wherein the one or more digestible polysaccharide hydrolysates have a Dextrose Equivalence of 28-31.

11. The product according to claim 6, wherein the one or more digestible polysaccharide hydrolysates have a Dextrose Equivalence of 17-20.

12. The product according to any one of claims 1-11, wherein the one or more digestible polysaccharide hydrolysates are a maltodextrin.

13. The product according to any one of claims claim 1-11, wherein the product has an osmolality of 170-295 mOsmoles/kg.

14. The product according to any one of claims 1-11, wherein the product is a liquid, concentrated or dried skim milk product or a liquid, concentrated or dried fat-containing milk product.

15. The product according to any one of claims 1-14, wherein the total mass of the DP1 sugar on a dry solids basis is greater than the total mass of the DP2 sugar on a dry solids basis.
